(19) United States
(12) Patent Application Publication
(10) Pub. No.: US 2014/0009599 A1
(43) Pub. Date: Jan. 9, 2014

(54) METHODS AND SYSTEMS FOR MONITORING THE GROWTH OF CARBON NANOSTRUCTURES ON A SUBSTRATE

(71) Applicant: APPLIED NANOSTRUCTURE SOLUTIONS, LLC., Baltimore, MD (US)

(72) Inventors: Jordan T. Ledford, Baltimore, MD (US); Harry C. Malecki, Abingdon, MD (US); Andy Chiu, Middle River, MD (US)

(21) Appl. No.: 13/913,289

(22) Filed: Jun. 7, 2013

Related U.S. Application Data
(60) Provisional application No. 61/667,916, filed on Jul. 3, 2012.

(51) Int. Cl. H04N 7/18

(52) U.S. Cl. CPC H04N 7/18
USPC 348/86; 382/141

(57) ABSTRACT

Carbon nanostructure growth on a substrate can be evaluated by visual imaging techniques. Methods for imaging carbon nanostructures on a substrate can include providing a plurality of carbon nanostructures infused to a substrate; acquiring an image of the plurality of carbon nanostructures while they are infused to the substrate; converting the image of the plurality of carbon nanostructures into a binary image, the binary image comprising a carbon nanostructure/substrate portion and an extraneous portion; and correlating the carbon nanostructure/substrate portion of the binary image with an amount of carbon nanostructures infused to the substrate. An illustrative substrate can be one or more fibers onto which carbon nanostructures are infused.

### CROSS-REFERENCE TO RELATED APPLICATIONS

This application claims the benefit of priority under 35 U.S.C. §119 from U.S. Provisional Patent Application 61/667,916, filed Jul. 3, 2012, which is incorporated herein by reference in its entirety.

### STATEMENT REGARDING FEDERALLY SPONSORED RESEARCH OR DEVELOPMENT

Not applicable.

### FIELD OF THE INVENTION

The present invention generally relates to carbon nanostructures, and, more specifically, to methods and systems for monitoring the growth of carbon nanostructures.

### BACKGROUND

Carbon nanostructures have been proposed for use in a number of applications that can take advantage of their unique combination of chemical, mechanical, electrical, and thermal properties. As used herein, the term “carbon nanostructures” refers to a composition comprising carbon nanotubes, some of which can be present in web-like structures that include that branched carbon nanotubes, crosslinked carbon nanotubes, and/or carbon nanotubes sharing common walls. In many instances, it can be desirable to tailor the properties of the carbon nanostructures in order to provide a specified type of feature enhancement in an application. For example, in the case of carbon nanotubes, carbon nanotube length, diameter and/or type can be determining factors of whether the carbon nanotubes are suitable for a particular application. The amount of carbon nanotubes that are present can also be a significant factor.

For batch production of “loose” carbon nanostructures (i.e., carbon nanostructures that are not bound to a substrate), there are a number of techniques that can be used to characterize the carbon nanostructures within a particular production batch. Illustrative characterization techniques that can be used to characterize carbon nanostructures include, for example, fluorescence spectroscopy, Raman spectroscopy, loss on ignition (LOI) techniques, electrical conductivity measurements, scanning or transmission electron microscopy, and the like. Some of these techniques reveal nanoscale properties that are diagnostic of the individual carbon nanostructures in a sample or a region of a sample, while others provide information that is characteristic of the bulk sample as a whole. Most significantly, none of these characterization techniques are particularly rapid, such that the carbon nanostructures can be characterized in real-time or near real-time as they are being produced or just after their production. Moreover, none of these characterization techniques are particularly automatable for high throughput analyses.

Carbon nanostructures that are infused to a substrate can be even more difficult to adequately characterize. As with “loose” carbon nanostructures, it can sometimes be desirable to characterize the carbon nanostructure lengths, diameters, and/or types when they are infused to a substrate. When carbon nanostructures are infused to a substrate, it can also be desirable to know if the carbon nanostructures are being grown uniformly and at a desired coverage density over the entirety of the substrate, or if the carbon nanostructure growth pattern has changed in some manner in certain portions of the substrate. For example, changes in the carbon nanostructure growth conditions can alter the uniformity and coverage density of the carbon nanostructures on a substrate, and in some cases, even different types of carbon nanostructures can be formed. Variance in the infusion of carbon nanostructures to a substrate can make the carbon nanostructure-infused substrate unsuitable for use in an intended application.

For commercial scale production of substrate-infused carbon nanostructures, characterization techniques that support continuous carbon nanostructure production with minimal operator input can be highly desirable. Although some of the techniques that can be used to characterize “loose” carbon nanostructures are also applicable to the analysis of substrate-infused carbon nanostructures, they may not be applicable to all types of substrates or rapid enough to support continuous carbon nanostructure production processes. Moreover, most of the foregoing techniques are not easily applied to the entirety of a substrate, thereby leaving open the possibility for unobserved variance in the substrate regions not being assayed. This issue can be particularly significant for high aspect ratio substrates, such as spoolable-length fiber substrates, where the great length of the substrates makes them susceptible to variation in carbon nanostructure infusion conditions from one end of the substrate to the other.

As mentioned above, carbon nanostructure growth on certain types of substrates can be particularly problematic to assay by conventional techniques. Some substrates can decompose at high temperatures or possess electrical conductivity, which can interfere with the analysis of carbon nanostructures by LOI or electrical conductivity measurements, respectively. For example, metal fibers and carbon fibers are electrically conductive, and it can be difficult to filter out the background fiber conductivity from that resulting from the infused carbon nanostructures. Conductivity measurements can also be influenced by the ratio of conducting to semiconducting carbon nanostructures that are present in a sample, and for fiber substrates, the degree of fiber tensioning can also affect the observed electrical conductivity. Moreover, electrical conductivity measurements are most accurate at relatively low carbon nanostructure loadings on a substrate, and decrease in accuracy as the carbon nanostructure substrate loading increases. For LOI techniques, the decomposition temperature of the substrate usually needs to be higher than that of the infused carbon nanostructures in order to determine the amount of infused carbon nanostructures that are present (e.g., by weighing the residual substrate after carbon nanostructure removal). Low decomposition temperatures of carbon and aramid fibers, for example, can make the analysis of carbon nanotube infusion by LOI techniques problematic for these types of fibers. Low melting point substrates can also be problematic in this regard. Moreover, carbonaceous impurities can lead to an inaccurate determination of the quantity of carbon nanostructures that are present in a sample when using LOI techniques.

For problematic substrates such as carbon fibers, aramid fibers, and some metal fibers, there is no existing technique suitable for determining the degree of carbon nanostructure infusion to the fibers short of simply weighing the fiber reel before and after carbon nanostructure infusion takes place. Not only is this technique rather unsophisticated, but it provides no feedback whatsoever regarding the uniformity of carbon nanostructure infusion from one end of the fiber reel to the other. Similar issues can be encountered with destructive techniques, such as LOI, where only the end regions of continuous-length fiber substrates are typically analyzed, at least without undesirably cutting the fiber into smaller lengths for mid-fiber sampling. In summary, existing techniques for monitoring the growth of carbon nanostructures on a substrate are typically fraught by one or more difficulties that can include the inability to perform analyses in real-time, lack of automation capabilities, long measurement times, destructive sampling, difficulties in analyzing the entirety of a sample, and incompatibilities with certain substrates.

In view of the foregoing, systems and methods that permit carbon nanostructure infusion to a substrate to be readily monitored, ideally in real-time or near real-time and essentially independent of the type of substrate being infused, would represent a significant advance in the art. The present disclosure satisfies the foregoing needs and provides related advantages as well.

### SUMMARY

In some embodiments, the present disclosure describes methods including providing a plurality of carbon nanostructures infused to a substrate; acquiring an image of the plurality of carbon nanostructures while they are infused to the substrate; converting the image of the plurality of carbon nanostructures into a binary image, the binary image having a carbon nanostructure/substrate portion and an extraneous portion; and correlating the carbon nanostructure/substrate portion of the binary image with an amount of carbon nanostructures infused to the substrate.

In some embodiments, the present disclosure describes methods including infusing a plurality of carbon nanostructures onto a moving fiber under carbon nanostructure growth conditions; acquiring a visible light image of the plurality of carbon nanostructures while they are infused to the moving fiber; converting the visible light image of the plurality of carbon nanostructures into a binary image, the binary image having a carbon nanostructure/fiber portion and an extraneous portion; identifying the carbon nanostructure/fiber portion of the binary image; and correlating the carbon nanostructure/fiber portion of the binary image with an amount of carbon nanostructures infused to the substrate.

In some embodiments, the present disclosure describes imaging systems including a carbon nanostructure growth chamber configured to infuse carbon nanostructures to one or more moving fibers under carbon nanostructure growth conditions; a first image acquisition mechanism configured to obtain a first image of the one or more moving fibers after they have exited the carbon nanostructure growth chamber and had carbon nanostructures infused thereto; and a processing mechanism configured to convert the first image into a first binary image having a carbon nanostructure/fiber portion and an extraneous portion, the processing mechanism also being configured to correlate the carbon nanostructure/fiber portion of the first binary image with an amount of carbon nanostructures infused to each moving fiber.

The foregoing has outlined rather broadly the features of the present disclosure in order that the detailed description that follows can be better understood. Additional features and advantages of the disclosure will be described hereinafter, which form the subject of the claims

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIG. 1 shows a schematic generally depicting processes in which carbon nanostructure growth on a substrate is monitored by visual imaging;

FIGS. 2 and 3 show side-view schematics of illustrative imaging systems configured for monitoring the growth of carbon nanostructures on a substrate;

FIG. 4 shows a top view, expanded schematic of the imaging system of FIG. 2 immediately before and after the carbon nanostructure growth chamber;

FIGS. 5A-5C demonstrate an illustrative process showing how images of carbon nanostructure-infused fibers can be further processed to determine the amount of carbon nanostructures that are present on a fiber;

FIG. 6 shows an illustrative calibration curve and calibration function that can be used to determine the amount of carbon nanostructures that are present on a fiber;

FIG. 7 shows an illustrative screenshot of the output obtained from monitoring the infusion of carbon nanostructures to a fiber over time;

FIG. 8 shows a top view schematic of an illustrative imaging system containing two image acquisition mechanisms that are differentially positioned with respect to one another;

FIG. 9 shows a schematic of the imaging system of FIG. 8 as viewed parallel to the direction of fiber conveyance from the exit of the carbon nanostructure infusion chamber; and

FIGS. 10A-10C demonstrate illustrative process images from two differentially positioned visible light cameras imaging the same fibers from different relative positions.

### DETAILED DESCRIPTION

The present disclosure is directed, in part, to imaging methods for monitoring carbon nanostructure growth. The present disclosure is also directed, in part, to imaging systems configured for monitoring the growth of carbon nanostructures.

As discussed above, monitoring the growth of carbon nanostructures can be problematic in many instances, particularly when the carbon nanostructures are being infused directly onto a substrate. Some currently used analytical techniques are limited in the types of substrates that they can be used to analyze, and some techniques monitor observables that are a function of carbon nanotube type (e.g., fluorescence spectroscopy and electrical conductivity measurements) and may not be representative of the sample as a whole. A further difficulty with existing carbon nanostructure characterization techniques is that they are typically slow and often require considerable operator input. As a result, they can be incompatible with continuous carbon nanostructure production processes, in which it can be desirable to monitor the growth of carbon nanostructures on a continuous or semi-continuous basis throughout the production process, particularly for carbon nanostructure infusion onto high aspect ratio substrates, such as fibers.

In response to the foregoing shortcomings, the present inventors sought to develop methods and systems that could be used to simply monitor continuously operating carbon nanostructure growth processes, particularly processes for infusing carbon nanostructures to a substrate. The inventors sought to develop methods and systems that could be generally applied to any type of carbon nanostructure being grown upon any type of substrate, thereby addressing the above difficulties. More particularly, the inventors sought to develop methods and systems that could be used to assay the entirety or at least a substantial majority of a substrate surface after the infusion of carbon nanostructures thereto, thereby providing a better measure of quality control compared to regional analysis of the carbon nanostructure-infused substrate.

For many applications, measuring the quantity of carbon nanostructures infused to a substrate surface can be an adequate characterization for determining if the carbon nanostructure-infused substrate is suitable for a particular end use. For non-problematic substrates, LOI techniques can be applied to this end. As an alternative to LOI and other characterization techniques, the present inventors recognized that as the amount of carbon nanostructures infused to a substrate increases, the physical size of the substrate also increases in a measurable way. In the case of carbon nanostructure-infused fibers, the inventors recognized that the fiber diameter increases as a function of the amount of carbon nanostructures present, thereby allowing the fiber diameter to be correlated with the quantity of infused carbon nanostructures by employing a standard calibration function, which can be obtained from known samples. For substantially uniform carbon nanostructure growth, the fiber diameter and the corresponding amount of carbon nanostructures can be a function of the carbon nanostructure length. Thus, by measuring the amount of carbon nanostructures that are infused to a substrate, a carbon nanostructure length can also be determined using the methods described herein.

To determine the size of a substrate having carbon nanostructures infused thereto, the present inventors recognized that visual imaging techniques (although not necessarily with visible light) could be used to determine the substrate size after carbon nanostructure infusion, thereby allowing the carbon nanostructure loading on the substrate to be determined from the calibration function. Photographic images can be applied to this end. As an alternative to photographic images, an infrared imaging system can be used in some embodiments to produce a visual depiction of a thermal image of carbon nanostructures based on their retained heat following carbon nanostructure growth. Such thermal images or other visual images can be analyzed in a like manner to photographic images according to the embodiments described herein. Visual imaging methods can provide a number of advantages over carbon nanostructure analytical techniques that are presently used in the art. First, the imaging methods can be simply and non-destructively carried out with inexpensive visible light cameras having conventional image resolution capabilities. Moreover, standard image processing and instrument control software can be employed. Second, the imaging methods are essentially independent of the type of substrate that is present, thereby allowing carbon nanostructure infusion to problematic substrates to be studied. Third, the image acquisition and analyses can be carried out rapidly, in real-time or near real-time, to produce an output of product quality as carbon nanostructure infusion takes place. The rapid analyses of the present methods can allow a much greater quantity of substrate to be monitored per unit time than in existing techniques. Moreover, by monitoring for changes in the carbon nanostructure growth in real-time or near real-time, there can be proactive feedback to the growth process to change a parameter of carbon nanostructure growth conditions to address an out-of-range carbon nanostructure quantity. Fourth, the methods can be practiced with high automation and very little operator input needed, if any. Fifth, the methods can be effective at high carbon nanostructure loadings and can complement the results obtained from conductivity measurements, which are often more effective at low carbon nanostructure loadings. Finally, the methods can be carried out to obtain multiple images of the same location within the substrates, but from different relative imaging locations, thereby allowing inconsistencies that can arise from two-dimensional imaging to be filtered out of the analytical results.

As used herein, the term “infused” means bonded, and “infusion” will refer to the process of bonding. Such bonding can involve direct covalent bonding, ionic bonding, pi-pi, and/or van der Waals force-mediated physisorption. For example, in some embodiments, carbon nanostructures can be directly bonded to a substrate. Bonding can also be indirect, such as the infusion of carbon nanostructures to a substrate via a barrier coating and/or an intervening transition metal nanoparticle disposed between the carbon nanostructures and the substrate. The particular manner in which carbon nanostructures are “infused” to a substrate will be referred to herein as a “bonding motif.” The terms “infused” and “bonded” and the terms “infusion” and “bonding” will be used synonymously with one another herein. In some embodiments, carbon nanostructures can become infused to a substrate by growing the carbon nanostructures on the substrate. Accordingly, the terms “infuse” and “infusion” will also be used synonymously herein with the terms “grow” and “growth.”

As used herein, the term “image” will refer to a visual depiction, although not necessarily using visible light.

As used herein, the term “substrate” will refer to any surface upon which carbon nanostructures are infused. Suitable substrates can include, for example, fibers, wafers, sheets, and the like. Suitable fibers can include, for example, filaments, tows, yarns, rovings, fiber braids, woven fabrics, non-woven fabrics, non-woven fiber mats, fiber plies, and the like.

As used herein, the term “binary image” will refer to a processed image in which a desired portion of a raw image has been unitarily converted into a first color and an undesired portion of a raw image has been unitarily converted into a second color. In the embodiments described herein, the carbon nanostructures and substrate are presented in a first color in the binary image, and the reminder of the binary image is presented in a second color.

As used herein, the term “extraneous portion” will refer to the undesired portion of a binary image that is not related to a substrate or carbon nanostructures grown thereon.

As used herein, the term “pixel” will refer to a display unit of uniform size that is combined to make up a larger image. As used herein, the term “pixelating” will refer to the process of breaking up a larger image into pixels.

As used herein, the term “calibration function” will refer to a mathematical relationship that associates two parameters with one another over a calibration range.

As used herein, the term “linespeed” will refer to the rate at which a substrate is conveyed through a location in which carbon nanostructure growth conditions are present. Suitable carbon nanostructure growth conditions are specified in more detail hereinbelow.

As used herein, the term “real-time” will refer to a substantially instantaneous acquisition of a raw image and feedback of processed data therefrom. As used herein, the term “near real-time” will refer to a substantially instantaneous acquisition of a raw image but a delayed feedback of processed data therefrom (e.g., due to processing delays).

As used herein, the term “visible light image” refers to an image that is viewable by the human eye. Visible light images are commonly referred to as “pictures” or “photographs,” or an electronic file thereof.

In some embodiments, methods described herein can include providing a plurality of carbon nanostructures that are infused to a substrate; acquiring an image of the plurality of carbon nanostructures while they are infused the substrate; converting the image of the plurality of carbon nanostructures into a binary image, the binary image having a carbon nanostructure/substrate portion and an extraneous portion; and correlating the carbon nanostructure/substrate portion of the binary image with an amount of carbon nanostructures infused to the substrate.

Converting the image of the plurality of carbon nanostructures into a binary image can include depicting the carbon nanostructures and the substrate onto which the carbon nanostructures are infused as a first color and depicting the remaining portions of the image as a second color in the binary image. For example, in some embodiments, the binary image can be depicted in black and white, where either the black or the white portions of the binary image can be related to the carbon nanostructures and substrate. Conversion to a binary image and further analysis of the binary image can take place using standard image processing mechanisms, which can include software or hardware. For example, in some embodiments, image processing and analysis can be accomplished with LABVIEW software, which is available from National Instruments. The image processing mechanism can also be operable to produce an output of the amount of carbon nanostructures that are infused to a substrate.

Suitable image processing mechanisms for converting the image of the plurality of carbon nanostructures into a binary image and subsequently processing the binary image to determine the amount of carbon nanostructures that are present are not believed to be particularly limited. Suitable image processing mechanisms can include various blocks, modules, elements, components, methods, algorithms, and the like, any of which can be implemented using computer hardware, software, combinations thereof, and the like. To illustrate this interchangeability of hardware and software, various illustrative blocks, modules, elements, components, methods, algorithms, and the like have been described generally in terms of their functionality. Whether such functionality is implemented as hardware or software will depend upon the particular application and any imposed design constraints. For at least this reason, it is to be recognized that one of ordinary skill in the art can implement the described functionality in a variety of ways for a particular application. Further, various components and blocks can be arranged in a different order or partitioned differently, for example, without departing from the scope of the embodiments expressly described.

Computer hardware used to implement the various illustrative blocks, modules, elements, components, methods, algorithms, and the like described herein can include a processor configured to execute one or more sequences of instructions, programming stances, or code stored on a non-transitory, computer-readable medium. The processor can be, for example, a general purpose microprocessor, a microcontroller, a digital signal processor, an application specific integrated circuit, a field programmable gate array, a programmable logic device, a controller, a state machine, a gated logic, discrete hardware components, an artificial neural network, or any like suitable entity that can perform calculations or other manipulations of data. In some embodiments, computer hardware can further include elements such as, for example, a memory [e.g., random access memory (RAM), flash memory, read only memory (ROM), programmable read only memory (PROM), erasable read only memory (EPROM)], registers, hard disks, removable disks, CD-ROMS, DVDs, or any other like suitable storage device or medium.

Executable sequences described herein can be implemented with one or more sequences of code contained in a memory. In some embodiments, such code can be read into the memory from another machine-readable medium. Execution of the sequences of instructions contained in the memory can cause a processor to perform the process steps described herein. One or more processors in a multi-processing arrangement can also be employed to execute instruction sequences in the memory. In addition, hard-wired circuitry can be used in place of or in combination with software instructions to implement various embodiments described herein. Thus, the present embodiments are not limited to any specific combination of hardware and/or software.

As used herein, a machine-readable medium will refer to any medium that directly or indirectly provides instructions to a processor for execution. A machine-readable medium can take on many forms including, for example, non-volatile media, volatile media, and transmission media. Non-volatile media can include, for example, optical and magnetic disks. Volatile media can include, for example, dynamic memory. Transmission media can include, for example, coaxial cables, wire, fiber optics, and wires that form a bus. Common forms of machine-readable media can include, for example, floppy disks, flexible disks, hard disks, magnetic tapes, other like magnetic media, CD-ROMs, DVDs, other like optical media, punch cards, paper tapes and like physical media with patterned holes, RAM, ROM, PROM, EPROM and flash EPROM.

In some embodiments, providing a plurality of carbon nanostructures infused to a substrate can include growing the carbon nanostructures on the substrate under carbon nanostructure growth conditions. Suitable carbon nanostructure growth conditions are specified in more detail hereinbelow. In some embodiments, the substrate can be moving while being exposed to the carbon nanostructure growth conditions. For example, in some embodiments, methods described herein can include infusing a plurality of carbon nanostructures onto a fiber while the fiber is moving, where the carbon nanostructures are infused to the fiber under carbon nanostructure growth conditions.

In some embodiments, the image of the plurality of carbon nanostructures can be obtained with visible light. That is, in such embodiments, the image of the carbon nanostructures can be a visible light image, such as a photographic image. Inexpensive visible light cameras can be used as image acquisition mechanisms for obtaining visible light images when practicing the embodiments described herein. Other suitable sources of electromagnetic radiation for obtaining an image of the carbon nanostructures can include, for example, infrared radiation (for a thermal image) and x-ray radiation. Suitable image acquisition mechanisms for these alternative forms of electromagnetic radiation will be familiar to one having ordinary skill in the art.

The type of substrate onto which the carbon nanostructures are infused is not believed to be particularly limited. Generally, any substrate onto which carbon nanostructures can be grown can be analyzed according to the imaging methods described herein. Substrates can be electrically conductive or substantially non-conductive, transparent or opaque, and have melting points that vary over a broad range. Suitable substances onto which carbon nanostructures can be infused include, for example, glasses, carbon, ceramics, metals, organics (e.g., aramid substrates), and the like. Suitable substrate types can include fibers, wafers, sheets, tapes and the like. Fibers can include individual filaments, tows, yarns, rovings, fiber braids, woven fabrics, non-woven fabrics, non-woven fiber mats, fiber plies, and the like.

In some embodiments, the substrate onto which the carbon nanostructures are infused can be a fiber. Suitable fibers onto which carbon nanostructures can be infused and assayed according to the embodiments described herein can include, glass fibers, carbon fibers, metal fibers, ceramic fibers, organic fibers (e.g., aramid fibers), and the like. When monitoring carbon nanostructure growth on a fiber, the entirety of the fiber can be imaged (i.e., from end to end), or periodic imaging can be conducted at spaced apart locations along the length of the fiber. That is, imaging of the fiber can take place continuously or discontinuously. In some embodiments, the fibers can be continuous fibers that are of spoolable dimensions.

In some embodiments, methods described herein can include infusing a plurality of carbon nanostructures onto a moving fiber under carbon nanostructure growth conditions; acquiring a visible light image of the plurality of carbon nanostructures while they are infused the moving fiber; converting the visible light image of the plurality of carbon nanostructures into a binary image, the binary image having a carbon nanostructure/fiber portion and an extraneous portion; identifying the carbon nanostructure/fiber portion of the binary image; and correlating the carbon nanostructure/fiber portion of the binary image with an amount of carbon nanostructures infused to the moving fiber.

Although the methods described herein can be suitable for use in conjunction with assaying carbon nanostructures on a moving fiber, it is also to be recognized that the methods can also be practiced while the fiber is not moving, if desired. That is, in some embodiments, the fiber can be moving while acquiring the image of the plurality of carbon nanostructures, and in other embodiments, the fiber can remain stationary while the image is being acquired. The former embodiments can be particularly compatible with continuous carbon nanostructure infusion processes onto a substrate of spoolable dimensions.

In the remainder of this description, in the interest of clarity, the term “substrate” will be used to generally refer to the surface onto which a plurality of carbon nanostructures are infused, even if a particular embodiment is referring to a substrate that is a fiber. Thus, it is to be recognized that the terms “substrate” and “fiber” can be used interchangeably in the remainder of this description, unless otherwise specified.

In some embodiments, methods described herein can include identifying the carbon nanostructure/substrate portion of the binary image. In some embodiments, identifying the carbon nanostructure/substrate portion of the binary image can include identifying a minimum region of the binary image that encompasses the entirety of the carbon nanostructure/substrate portion for a particular substrate. Identifying the carbon nanostructure/substrate portion can allow multiple substrates, if present, to be identified in a single image and quantified separately. The area represented by the carbon nanostructure/substrate portion in the binary image can then be determined according to techniques that are described hereinafter, and the area can then be correlated to the amount of carbon nanostructures that are infused to the substrate. Additional details regarding identifying the carbon nanostructure/substrate portion are also provided hereinbelow.

In some embodiments, converting the image of the plurality of carbon nanostructures into a binary image can further include pixelating the carbon nanostructure/substrate portion of the binary image into a plurality of pixels. By pixelating the carbon nanostructure/substrate portion, its area can be determined by counting the number of pixels that are present in each identified carbon nanostructure/substrate portion. In some embodiments, methods described herein can further include determining a number of pixels in the carbon nanostructure/substrate portion. In accordance with some embodiments, determining a number of pixels can take place automatically using a processing mechanism (e.g., using software control). In some embodiments, correlating the carbon nanostructure/substrate portion of the binary image with an amount of carbon nanostructures that are infused to the substrate can include inputting the number of pixels into a calibration function that relates the number of pixels to an amount of carbon nanostructures that are infused to the substrate. Further details regarding the calibration function and its determination are provided hereinbelow.

It is to be recognized that pixelating the carbon nanostructure/substrate portion of the binary image and then counting pixels is but one way to determine the area of the carbon nanostructure/substrate portion. In alternative embodiments, the image area of the carbon nanostructure/substrate portion can be determined by polygonal approximation techniques, for example, and the resulting area can be input to a calibration function in a manner similar to that described above. Other techniques for area determination can be envisioned by one having ordinary skill in the art.

In some embodiments, after inputting the number of pixels or the area of the carbon nanostructure/substrate portion to the calibration function, an output of the amount of carbon nanostructures that are present on the substrate can be obtained. In some embodiments, the output can be stored to a machine-readable storage medium. In some embodiments, the output can be plotted as it is being determined.

In some embodiments, methods described herein can include acquiring a plurality of images of the carbon nanostructures at spaced apart locations on the substrate. Imaging the substrate in this manner can permit the uniformity of carbon nanostructure growth to be better determined over the entirety of the substrate. For example, when the substrate is a fiber, methods described herein can include acquiring a plurality of images of the carbon nanostructures at spaced apart locations along the length of the fiber. In some embodiments, the entirety of the fiber length can be assayed. That is, in such embodiments, images of the fiber can be obtained continuously following infusion of carbon nanostructures thereto. In other embodiments, a plurality of images can be obtained at spaced apart locations along the length of the fiber, but without continuously obtaining the images. That is, periodic imaging of the fiber can be sufficient in such embodiments. Each image can then be subsequently converted into a binary image and further processed as described above.

In some embodiments, methods described herein can include acquiring a plurality of images of the carbon nanostructures at spaced apart locations along a fiber; converting each image into a binary image, each binary image having a carbon nanostructure/fiber portion and an extraneous portion; and correlating the carbon nanostructure/fiber portion of each binary image with an amount of carbon nanostructures infused to the fiber at each spaced apart location along the fiber.

The methods and systems described herein can be further advantageous in that they can account for substrate variances, particularly in fibers, that can change the visible appearance of the substrates and the apparent amount of infused carbon nanostructures. For example, fiber substrates can have a “twist” or “kink” in the fiber that can alter the apparent amount of carbon nanostructures that are infused thereto. If a fiber twist is imaged in accordance with the embodiments described herein, the calculated amount of carbon nanostructures at the fiber twist can differ dramatically from the quantity of infused carbon nanostructures on either side of the fiber twist, even if the true quantity of infused carbon nanostructures does not significantly vary. Methods and systems described herein can filter out such variances in determining the amount of carbon nanostructures that are infused to the fiber. For example, a running average of the calculated amount of infused carbon nanostructures can be determined at various spaced apart locations along the fiber. If, for example, a single data point deviates by more than a pre-determined amount from the running average, the data point can be disregarded as an outlier in calculating the future running average. The data can be saved and reprocessed later if needed. If, however, multiple data points in succession deviate appreciably from the running average, or if the running average is increasing or decreasing outside acceptable limits over time, there can be an alert generated that the production run is outside of its intended specification. If such an alert occurs, the production run can be stopped due to quality control standards not being met, or the carbon nanostructure growth conditions can be altered to bring the product back into a desired specification.

In some embodiments, methods described herein can further include determining if the amount of carbon nanostructures infused to the substrate (fiber) is within a desired range. Generally, an amount of carbon nanostructures infused to a fiber can range between about 0.1% to about 40% of the carbon nanostructure-infused fiber by weight. As discussed above, the amount of carbon nanostructures infused to a fiber and the variance thereof that are suitable for use in a particular application will be able to be chosen by one having ordinary skill in the art.

If the amount of carbon nanostructures infused to the substrate is not within a desired range, the carbon nanostructure production run can be stopped, if desired. In other embodiments, the carbon nanostructure growth conditions can be altered in an attempt to bring the amount of infused carbon nanostructures back within a desired range. For example, if the running average of the carbon nanostructure weight percentage is trending upward or downward and is approaching an endpoint of the desired range, the carbon nanostructure growth conditions can be altered in an attempt to maintain the amount of infused carbon nanostructures within specifications. Alternatively, if the running average has moved outside the desired range, the carbon nanostructure growth conditions can be altered to return the amount of infused carbon nanostructures back within the desired range. In some instances, minor variance of this sort may be acceptable for quality control purposes.

More generally, in some embodiments, methods described herein can further include altering a parameter of the carbon nanostructure growth conditions in response to an out-of-range amount of infused carbon nanostructures. Parameters of the carbon nanostructure growth conditions that can be altered in response to an out-of-range value can include the growth temperature, feed gas pressures, feed gas flow rates, the ratio of feed gas to diluent gas, and, for fiber substrates, the linespeed at which the fiber passes through a chamber in which the carbon nanostructure growth conditions are present. Alteration of the amount of carbon nanostructures that are grown on the fiber can be influenced most simply by changing the length of time that the fiber is exposed to the carbon nanostructure growth conditions. In some embodiments, changing the length of time that the fiber is exposed to the carbon nanostructure growth conditions can include changing a linespeed of the fiber as it passes through the carbon nanostructure growth conditions. Suitable fiber linespeeds are set forth in more detail hereinbelow.

In some embodiments, altering a parameter of the carbon nanostructure growth conditions in response to an out-of-range amount of carbon nanostructures can take place in real-time or near real-time. In such embodiments, feedback from the carbon nanostructure infusion process can be used to further moderate the process while carbon nanostructure growth takes place. In other embodiments, altering a parameter of the carbon nanostructure growth conditions can take place after a production run has been completed. For example, if it is determined that a production run is out of specification due to an undesired quantity of carbon nanostructures, the carbon nanostructure growth conditions can be altered for subsequent production runs.

Hereinafter, the methods and systems of the present disclosure will be described in more detail with reference to visible light imaging of one or more fibers onto which carbon nanostructures are being infused. In the following description, two-dimensional imaging of the fibers is described using a single image acquisition mechanism, such as a visible light camera. Other embodiments are described subsequently, in which multiple image acquisition mechanisms are used to obtain images of the fibers from different viewing angles for composite data analysis. The systems and methods can be modified in accordance with any of the embodiments described hereinabove.

In some embodiments, the imaging systems described herein can include a carbon nanostructure growth chamber configured to infuse carbon nanostructures to one or more moving fibers under carbon nanostructure growth conditions; a first image acquisition mechanism configured to obtain a first image of the one or more moving fibers after they have exited the carbon nanostructure growth chamber and had carbon nanostructures infused thereto; and a processing mechanism configured to convert the first image into a first binary image having a carbon nanostructure/fiber portion and an extraneous portion, the processing mechanism also being configured to correlate the carbon nanostructure/fiber portion of the first binary image with an amount of carbon nanostructures infused to each moving fiber. In some embodiments, the first image acquisition system can include a visible light camera.

In some embodiments, the processing mechanism can be further configured to pixelate the carbon nanostructure/fiber portion of the first binary image into a first pixelated image containing a plurality of pixels and to determine the number of pixels in the carbon nanostructure/fiber portion of the first pixelated image. In addition, the processing mechanism can be configured to determine an amount of carbon nanostructures on each fiber that has been exposed to carbon nanostructure growth conditions. In some embodiments, the processing mechanism can be further configured to change one or more parameters of the carbon nanostructure growth conditions in response to an out-of-range amount of carbon nanostructures infused to the one or more moving fibers. In some embodiments, the processing mechanism can be configured to change a linespeed of the one or more moving fibers passing through the carbon nanostructure growth chamber in response to an out-of-range amount of carbon nanostructures infused to the one or more moving fibers.

In some embodiments, a backlight can be employed while the carbon nanostructures on the fibers are being imaged. The backlight can be used to improve the contrast of the images obtained from the carbon nanostructure-infused fibers. In various embodiments, the backlight can be disposed such that the one or more moving fibers are positioned between the first image acquisition mechanism and the backlight.

Before discussing embodiments in which multiple image acquisition mechanisms are present, the methods and systems described herein will now be further described with reference to the drawings.

FIG. 1 shows a schematic generally depicting processes in which carbon nanostructure growth on a substrate is monitored by visual imaging. In FIG. 1, carbon nanostructure growth on a substrate takes place in operation 2. Thereafter, an image of the carbon nanostructure-infused substrate is acquired in operation 4. In operation 6, processing of the image obtained in operation 4 takes place to produce a binary image of the carbon nanostructure-infused substrate. The binary image of the carbon nanostructure-infused substrate is then further analyzed in operation 8 to identify the carbon nanostructure/substrate portions that are present in the binary image. After identifying the carbon nanostructure/substrate portions in the binary image, the area of the carbon nanostructure/substrate portions in the binary image can be determined in operation 10. For example, the area of the carbon nanostructure/substrate portions can be separately determined by counting the number of pixels that are present in each carbon nanostructure/substrate portion of the binary image. The area of the carbon nanostructure/substrate portions can then be input to a calibration function in operation 12 to determine the amount of infused carbon nanostructures on the substrate. Optionally, process feedback from operation 12 to operation 2 can be carried out to alter one or more parameters of the carbon nanostructure growth conditions.

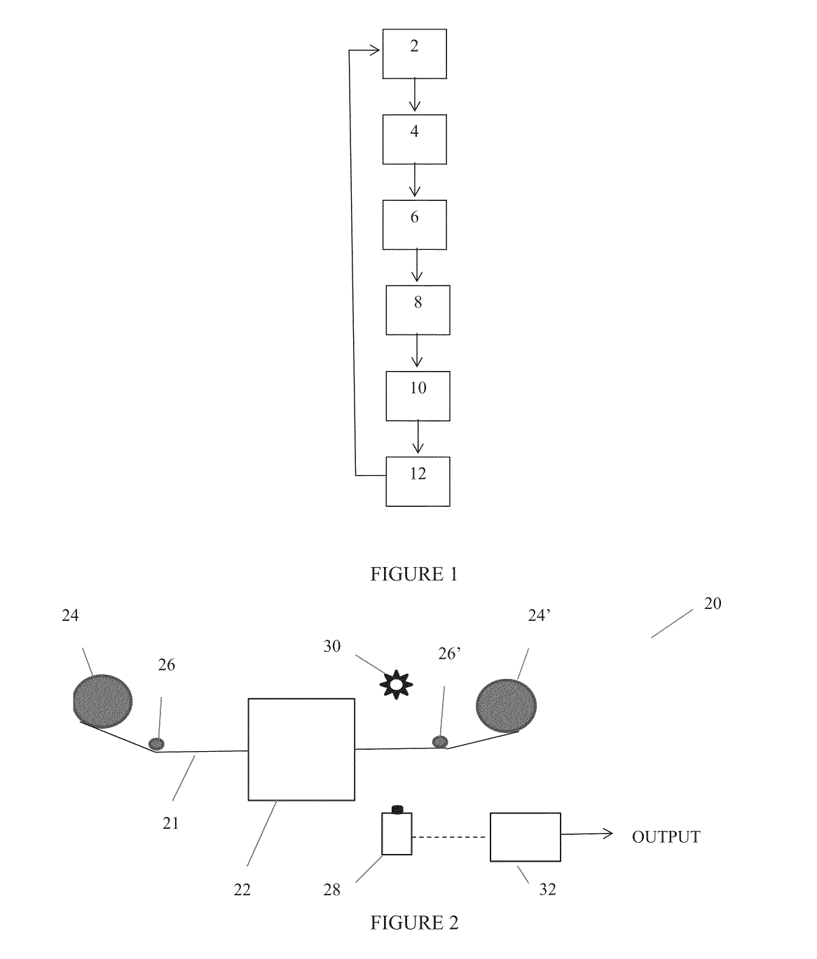

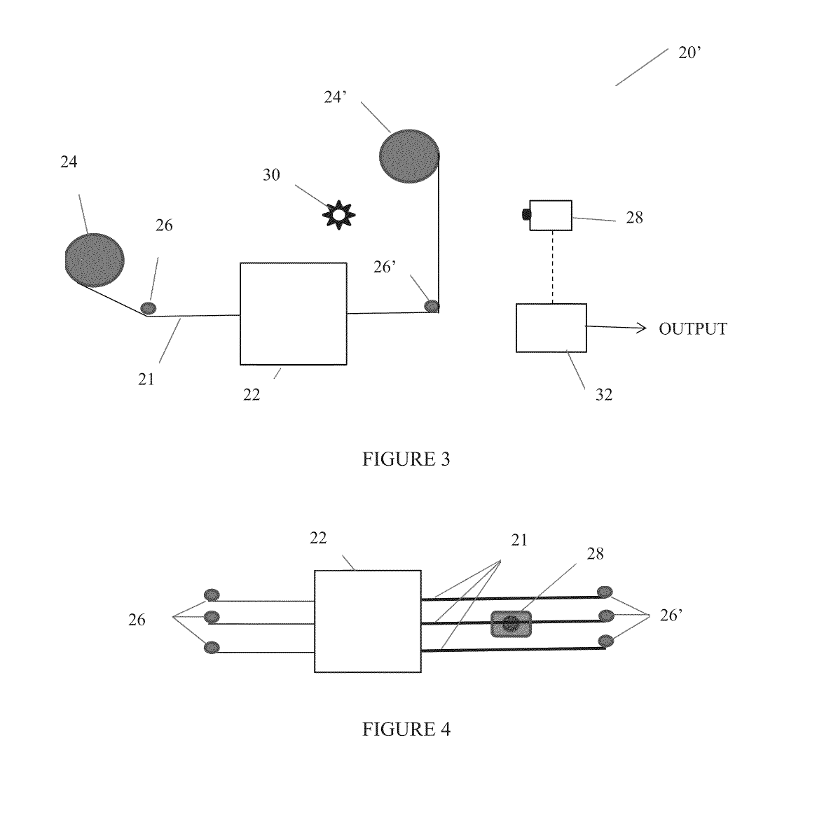

FIGS. 2 and 3 show side-view schematics of illustrative imaging systems configured for monitoring the growth of carbon nanostructures on a substrate. As depicted in FIGS. 2 and 3, the substrate includes one or more moving fibers. In FIGS. 2 and 3, imaging systems 20 and 20′, respectively, include a reel-to-reel processing system that is configured to convey one or more fibers 21 through carbon nanostructure growth chamber 22. The reel-to-reel processing system includes feed reel 24 and takeup reel 24′ and tensioning rollers 26 and 26′, disposed before and after carbon nanostructure growth chamber 22. After exiting carbon nanostructure growth chamber 22, fibers 21 have carbon nanostructures infused thereto.

After exiting carbon nanostructure growth chamber 22, an image of fibers 21 can be acquired with image acquisition mechanism 28, which can be a visible light camera in some embodiments. Systems 20 and 20′ can also include backlight 30 that is disposed opposite image acquisition mechanism 28 in order to improve the contrast of the fiber images. As depicted in FIG. 2, image acquisition mechanism 28 is configured to obtain the image of the carbon nanostructures on the fibers between an exit of carbon nanostructure growth chamber 22 and before tensioning roller 26′ disposed after carbon nanostructure growth chamber 22. By configuring image acquisition mechanism 28 for imaging the fibers in this manner, measurement inconsistencies can be lessened by reducing the possible compression of the carbon nanostructures by tensioning roller 26′. It is to be recognized that the positioning of image acquisition mechanism 28 and backlight 30 in system 20 of FIG. 2 is merely illustrative in nature, and various alternative configurations fall within the spirit and scope of the present disclosure. For example, in system 20′ of FIG. 3, image acquisition mechanism 28 and backlight 30 are positioned after tensioning roller 26′. After acquiring an image with image acquisition mechanism 28, processing of the image to produce an output can take place in processing mechanism 32, as generally described above and depicted in reference to FIG. 1.

FIG. 4 shows a top view, expanded schematic of the imaging system of FIG. 2 immediately before and after carbon nanostructure growth chamber 22. In the interest of clarity, only certain features of FIG. 2 have been depicted in FIG. 4. As depicted in FIG. 4, multiple fibers 21 can pass through carbon nanostructure growth chamber 22 and be imaged simultaneously by image acquisition mechanism 28. Although FIG. 4 has depicted the presence of three fibers 21, it is to be recognized that any number of fibers 21 can be imaged with the systems and methods described herein.

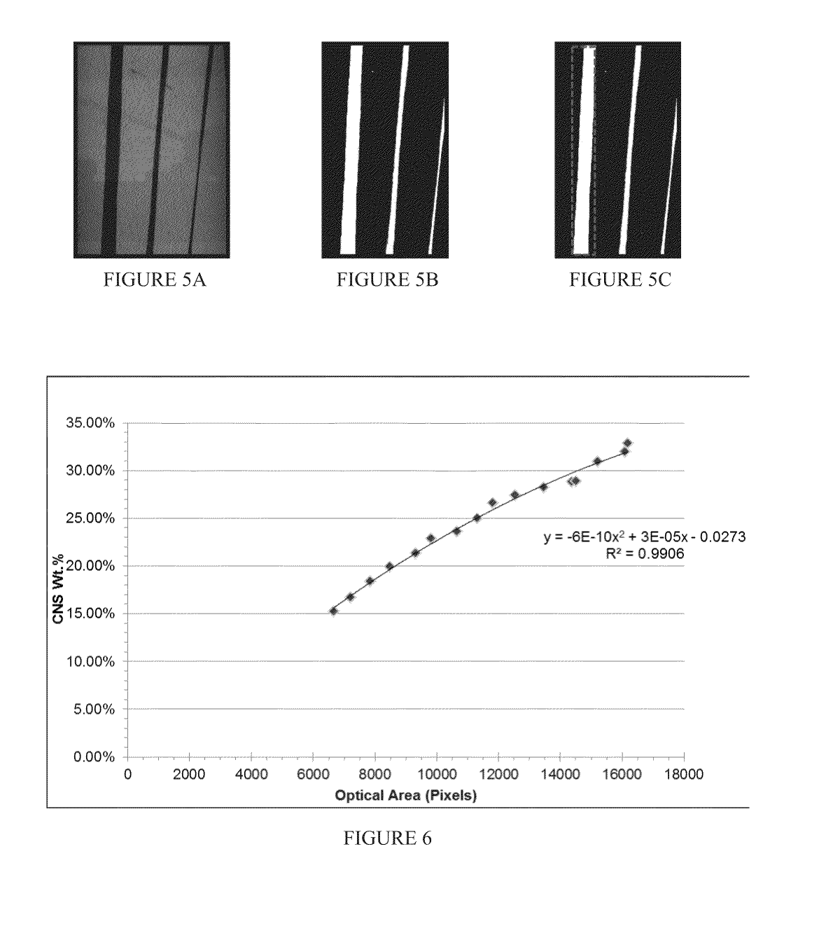

FIGS. 5A-5C demonstrate an illustrative process showing how images of carbon nanostructure-infused fibers can be further processed to determine the amount of carbon nanostructures that are present. Although FIG. 5A depicts visible light images of the carbon nanostructure-infused fibers, it is to be recognized that other types of images can be processed in a like manner. As shown in FIG. 5A, a visible light image of the carbon nanostructure-infused fibers is obtained. Subsequently, the visible light image of FIG. 5A is converted into a binary image, as illustrated in FIG. 5B, in which the carbon nanostructure/fiber portion of the image is depicted in white and the extraneous portions of the image are depicted in black. In FIG. 5C, the smallest possible region (dashed box) of the binary image is identified that contains the carbon nanostructure/fiber portion of a particular fiber. Within this identified region, the area of the carbon nanostructure/fiber portion is then determined (e.g., by counting pixels), and the calculated area (pixel count) is fed to a calibration function that can be used to correlate the amount of carbon nanostructures that are present for a given pixel count, as described further hereinafter. The calibration function can be determined by imaging carbon nanostructure-infused fibers having known amounts of carbon nanostructures infused thereto and determining the area (pixel count) of the carbon nanostructure/fiber portions within the images. Thereafter, the known data can be fit to an equation through standard curve fitting and regression techniques.

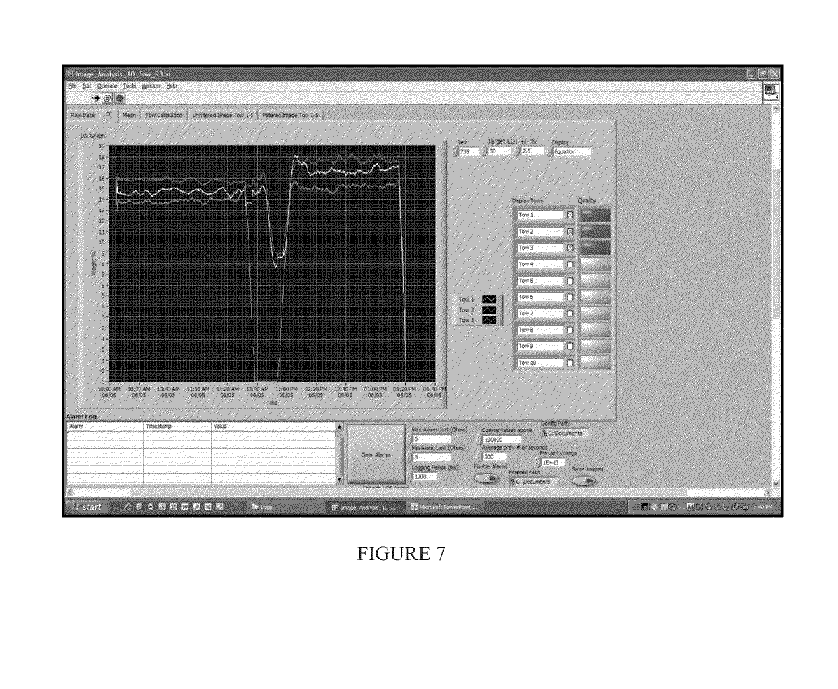

FIG. 6 shows an illustrative calibration curve and calibration function that can be used to determine the amount of carbon nanostructures that are present on a fiber. For the standard carbon nanostructure-infused fibers used to prepare the calibration curve in FIG. 6, the amounts of carbon nanostructures present were determined by LOI, which measures the weight percentage of carbon nanostructure present relative to the total weight of the carbon nanostructure-infused fiber. The calibration curve and calibration function depicted in FIG. 6 are based upon pixel counts to determine area, but as described above, any suitable area measurement technique can be used. The data fitting to determine the calibration function can be made using any suitable fitting protocol. Although the calibration function of FIG. 6 has been determined using a polynomial fit, it is to be recognized that other fitting protocols, such as linear fitting of the data can also be performed. FIG. 7 shows an illustrative screenshot of the output obtained from monitoring the infusion of carbon nanostructures to a fiber over time.

In some embodiments, two or more image acquisition mechanisms can be used to obtain an image of the substrate. In more particular embodiments, the two or more image acquisition mechanisms can be configured to image the same location within the substrate but from different physical orientations. By imaging a location within the substrate from two or more different imaging positions, a higher dimensionality and potentially more accurate analysis of the carbon nanostructure growth on the substrate can be assessed. For example, higher dimensionality analyses can be used to determine if there is anisotropy to the carbon nanostructure growth on the substrate. Moreover, when analyzing fibers and other complex substrates, higher dimensionality analyses can better determine if a change in the amount of infused carbon nanostructures is due to a fiber twist. For example, a fiber twist may be observed in a first viewing plane but not a second viewing plane. By having the imaging data available from a second viewing plane, the imaging data from the fiber twist can be more confidently rejected from the running average of the infused carbon nanostructure quantity. Finally, averaging the calculated amounts of infused carbon nanostructures determined from the different viewing planes can provide a more accurate assessment of the actual amount of carbon nanostructures that are present. When multiple images are obtained, image acquisition and analysis can be generally conducted as described hereinabove, with modifications being made as described above to consolidate the data obtained from different images.

In some embodiments, the imaging systems described herein can further include a second image acquisition mechanism configured to image the same location within the one or more moving fibers as the first image acquisition mechanism and to obtain a second image thereof. The second image acquisition mechanism is differentially positioned with respect to the one or more moving fibers relative to the first image acquisition mechanism. In some embodiments, the first image acquisition mechanism and the second image acquisition mechanism can be the same. In other embodiments, the first image acquisition mechanism and the second image acquisition mechanism can be different. In some embodiments, the first and second image acquisition mechanisms can both be visible light cameras.

In some embodiments, the processing mechanism can be further configured to convert the second image obtained by the second image acquisition mechanism into a second binary image. As with the first binary image, the second binary image can also have a carbon nanostructure/fiber portion and an extraneous portion. In some embodiments, the processing mechanism can be further configured to identify the carbon nanostructure/fiber portion of the second binary image and to determine an amount of carbon nanostructures infused to each moving fiber based upon an amount of carbon nanostructures present in each binary image.

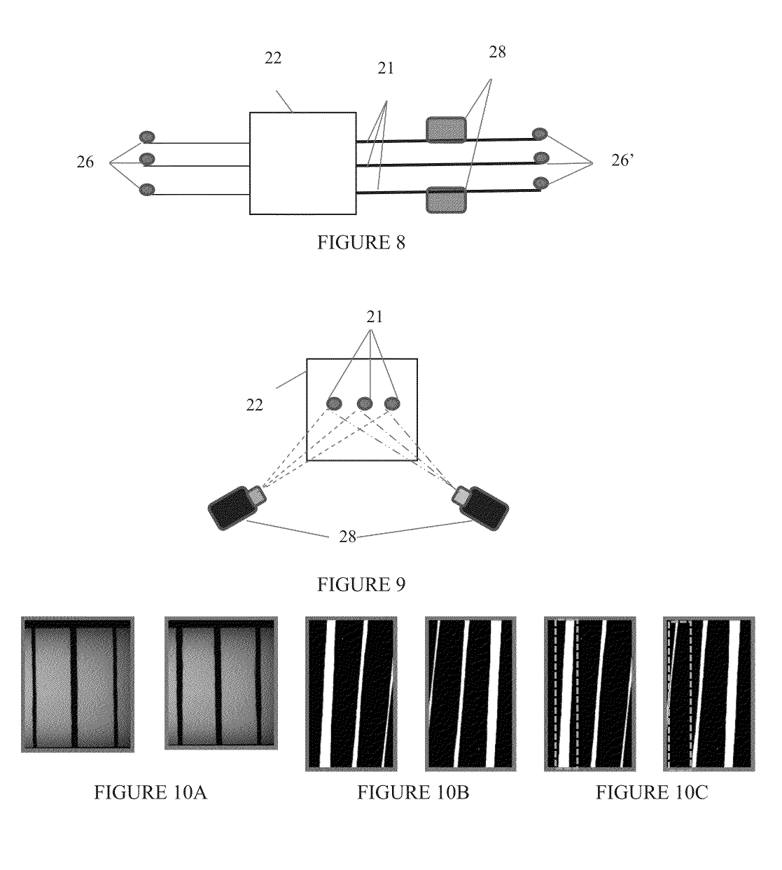

FIG. 8 shows a top view schematic of an illustrative imaging system containing two image acquisition mechanisms 28 that are differentially positioned with respect to one another. As will be evident from viewing FIG. 8, fibers 21 are presented differently to each image acquisition mechanism 28, thereby resulting in differing images obtained by each (see FIGS. 10A-10C). FIG. 9 shows a schematic of the imaging system of FIG. 8 as viewed parallel to the direction of fiber conveyance from the exit of the carbon nanostructure infusion chamber. In FIG. 9, the different angles at which image acquisition mechanisms 28 observe fibers 21 are presented for purposes of illustration. FIGS. 10A-10C demonstrate illustrative process images from two differentially positioned visible light cameras imaging the same fibers from different relative positions. As can be seen in FIGS. 10A-10C, depending on the camera angle, the apparent image of each fiber and its calculated image area can vary significantly if only a single two-dimensional image is considered.

The following description for producing carbon nanostructures under carbon nanostructure growth conditions is provided as guidance to the skilled artisan. For simplicity, the discussion of carbon nanostructure growth will be directed to carbon nanotubes (CNTs), since CNTs are a major component of carbon nanostructures grown according to the techniques set forth herein. Moreover, the description that follows is directed to carbon nanostructure growth on carbon fibers. However, it is to be recognized by those having ordinary skill in the art that carbon nanostructures can be produced on other substrates, including metal, glass, ceramic and organic fibers, for example, by similar methods.

CNTs infused on a carbon fiber material can alter various properties of the carbon fiber material, such as the fiber's thermal and/or electrical conductivity, and/or tensile strength, for example. The processes employed to make CNT-infused carbon fiber materials can provide CNTs with substantially uniform length and distribution to impart their useful properties uniformly over the carbon fiber material that is being modified. Furthermore, the processes disclosed herein are suitable for the generation of CNT-infused carbon fiber materials of spoolable dimensions.

The processes disclosed herein can be applied to nascent carbon fiber materials generated de novo before, or in lieu of, application of a typical sizing solution to the carbon fiber material. Alternatively, the processes disclosed herein can utilize a commercial carbon fiber material, for example, a carbon tow, that already has a sizing applied to its surface. In such embodiments, the sizing can be removed to provide a direct interface between the carbon fiber material and the synthesized CNTs, although a barrier coating and/or transition metal particle can serve as an intermediate layer providing indirect infusion, as explained further below. After CNT synthesis further sizing agents can be applied to the carbon fiber material as desired.

The processes described herein allow for the continuous production of carbon nanotubes of uniform length and distribution along spoolable lengths of tow, tapes, fabrics and other 3D woven structures. While various mats, woven and non-woven fabrics and the like can be functionalized by processes of the invention, it is also possible to generate such higher ordered structures from the parent tow, yarn or the like after CNT functionalization of these parent materials. For example, a CNT-infused woven fabric can be generated from a CNT-infused carbon fiber tow.

As used herein the term “carbon fiber material” refers to any material which has carbon fiber as its elementary structural component. The term encompasses fibers, filaments, yarns, tows, tows, tapes, woven and non-woven fabrics, plies, mats, and the like.

As used herein the term “spoolable dimensions” refers to carbon fiber materials having at least one dimension that is not limited in length, allowing for the material to be stored on a spool or mandrel. Carbon fiber materials of “spoolable dimensions” have at least one dimension that indicates the use of either batch or continuous processing for CNT infusion as described herein. One carbon fiber material of spoolable dimensions that is commercially available is exemplified by AS4 12k carbon fiber tow with a tex value of 800 (1 tex=1 g/1,000 m) or 620 yard/lb (Grafil, Inc., Sacramento, Calif.). Commercial carbon fiber tow, in particular, can be obtained in 5, 10, 20, 50, and 100 lb. (for spools having high weight, usually a 3k/12K tow) spools, for example, although larger spools may require special order. Processes of the invention operate readily with 5 to 20 lb. spools, although larger spools are usable. Moreover, a pre-process operation can be incorporated that divides very large spoolable lengths, for example 100 lb. or more, into easy to handle dimensions, such as two 50 lb spools.

As used herein, the term “carbon nanotube” (CNT, plural CNTs) refers to any of a number of cylindrically-shaped allotropes of carbon of the fullerene family including single-walled carbon nanotubes (SWNTs), double-walled carbon nanotubes (DWNTs), multi-walled carbon nanotubes (MWNTs). CNTs can be capped by a fullerene-like structure or remain open-ended. CNTs include those that encapsulate other materials. CNTs can appear in branched networks, entangled networks, and combinations thereof.

As used herein “uniform in length” refers to the length of CNTs grown in a reactor. “Uniform in length” means that the CNTs have lengths with tolerances of plus or minus about 20% of the total CNT length or less, for CNT lengths varying from between about 1 micron to about 500 microns. At very short lengths, such as 1-4 microns, this error may be in a range from between about plus or minus 20% of the total CNT length up to about plus or minus 1 micron, that is, somewhat more than about 20% of the total CNT length.

As used herein “uniform in distribution” refers to the consistency of density of CNTs on a carbon fiber material. “Uniform in distribution” means that the CNTs have a density on the carbon fiber material with tolerances of plus or minus about 10% coverage defined as the percentage of the surface area of the fiber covered by CNTs. This is equivalent to ±1500 CNTs/μm² for an 8 nm diameter CNT with 5 walls. Such a figure assumes the space inside the CNTs as fillable.

As used herein, the term “transition metal” refers to any element or alloy of elements in the d-block of the periodic table. The term “transition metal” also includes salt forms of the base transition metal element such as oxides, carbides, nitrides, and the like.

As used herein, the term “nanoparticle” or NP (plural NPs), or grammatical equivalents thereof refers to particles sized between about 0.1 to about 100 nanometers in equivalent spherical diameter, although the NPs need not be spherical in shape. Transition metal NPs, in particular, can serve as catalysts for CNT growth on the carbon fiber materials.

As used herein, the term “sizing agent,” “fiber sizing agent,” or just “sizing,” refers collectively to materials used in the manufacture of carbon fibers as a coating to protect the integrity of carbon fibers, provide enhanced interfacial interactions between a carbon fiber and a matrix material in a composite, and/or alter and/or enhance particular physical properties of a carbon fiber. In some embodiments, CNTs infused to carbon fiber materials behave as a sizing agent.

As used herein, the term “material residence time” refers to the amount of time a discrete point along a carbon fiber material of spoolable dimensions is exposed to CNT growth conditions during the CNT infusion processes described herein. This definition includes the residence time when employing multiple CNT growth chambers.

In some embodiments, the CNT-infused carbon fiber material includes a carbon fiber material of spoolable dimensions, a barrier coating conformally disposed about the carbon fiber material, and carbon nanotubes (CNTs) infused to the carbon fiber material. The infusion of CNTs to the carbon fiber material can include a bonding motif of direct bonding of individual CNTs to the carbon fiber material or indirect bonding via a transition metal NP, barrier coating, or both.

Without being bound by theory, transition metal NPs, which serve as a CNT-forming catalyst, can catalyze CNT growth by forming a CNT growth seed structure. In one embodiment, the CNT-forming catalyst can remain at the base of the carbon fiber material, locked by the barrier coating, and infused to the surface of the carbon fiber material. In such a case, the seed structure initially formed by the transition metal nanoparticle catalyst is sufficient for continued non-catalyzed seeded CNT growth without allowing the catalyst to move along the leading edge of CNT growth, as often observed in the art. In such a case, the NP serves as a point of attachment for the CNT to the carbon fiber material. The presence of the barrier coating can also lead to further indirect bonding motifs. For example, the CNT forming catalyst can be locked into the barrier coating, as described above, but not in surface contact with carbon fiber material. In such a case a stacked structure with the barrier coating disposed between the CNT forming catalyst and carbon fiber material results. In either case, the CNTs formed are infused to the carbon fiber material. In some embodiments, some barrier coatings will still allow the CNT growth catalyst to follow the leading edge of the growing nanotube. In such cases, this can result in direct bonding of the CNTs to the carbon fiber material or, optionally, to the barrier coating. Regardless of the nature of the actual bonding motif formed between the carbon nanotubes and the carbon fiber material, the infused CNT is robust and allows the CNT-infused carbon fiber material to exhibit carbon nanotube properties and/or characteristics.

Again, without being bound by theory, when growing CNTs on carbon fiber materials, the elevated temperatures and/or any residual oxygen and/or moisture that can be present in the reaction chamber can damage the carbon fiber material. Moreover, the carbon fiber material itself can be damaged by reaction with the CNT-forming catalyst itself. That is, the carbon fiber material can behave as a carbon feedstock to the catalyst at the reaction temperatures employed for CNT synthesis. Such excess carbon can disturb the controlled introduction of the carbon feedstock gas and can even serve to poison the catalyst by overloading it with carbon. The barrier coating employed in the invention is designed to facilitate CNT synthesis on carbon fiber materials.

Without being bound by theory, the barrier coating can provide a thermal barrier to heat degradation and/or can be a physical barrier preventing exposure of the carbon fiber material to the environment at the elevated temperatures. Alternatively or additionally, it can minimize the surface area contact between the CNT-forming catalyst and the carbon fiber material and/or it can mitigate the exposure of the carbon fiber material to the CNT-forming catalyst at CNT growth temperatures.

Compositions having CNT-infused carbon fiber materials are provided in which the CNTs are substantially uniform in length. In the continuous process described herein, the residence time of the carbon fiber material in a CNT growth chamber can be modulated to control CNT growth and ultimately, CNT length. This can provide a means to control specific properties of the CNTs grown. CNT length can also be controlled through modulation of the carbon feedstock and carrier gas flow rates and reaction temperature. Additional control of the CNT properties can be obtained by controlling, for example, the size of the catalyst used to prepare the CNTs. For example, 1 nm transition metal nanoparticle catalysts can be used to provide SWNTs in particular. Larger catalysts can be used to prepare predominantly MWNTs.

Additionally, the CNT growth processes employed are useful for providing a CNT-infused carbon fiber material with uniformly distributed CNTs on carbon fiber materials while avoiding bundling and/or aggregation of the CNTs that can occur in processes in which pre-formed CNTs are suspended or dispersed in a solvent solution and applied by hand to the carbon fiber material. Such aggregated CNTs tend to adhere weakly to a carbon fiber material and the characteristic CNT properties are weakly expressed, if at all. In some embodiments, the maximum distribution density, expressed as percent coverage, that is, the surface area of fiber covered, can be as high as about 55% assuming about 8 nm diameter CNTs with 5 walls. This coverage is calculated by considering the space inside the CNTs as being “tillable” space. Various distribution/density values can be achieved by varying catalyst dispersion on the surface as well as controlling gas composition and process speed. Typically for a given set of parameters, a percent coverage within about 10% can be achieved across a fiber surface. Higher density and shorter CNTs can be useful for improving mechanical properties, while longer CNTs with lower density are useful for improving thermal and electrical properties, although increased density is still favorable. A lower density can result when longer CNTs are grown. This can be the result of the higher temperatures and more rapid growth causing lower catalyst particle yields.

The compositions of the invention having CNT-infused carbon fiber materials can include a carbon fiber material such as a carbon filament, a carbon fiber yarn, a carbon fiber tow, a carbon tape, a carbon fiber-braid, a woven carbon fabric, a non-woven carbon fiber mat, a carbon fiber ply, and other 3D woven structures. Carbon filaments include high aspect ratio carbon fibers having diameters ranging in size from between about 1 micron to about 100 microns. Carbon fiber tows are generally compactly associated bundles of filaments and are usually twisted together to give yarns.

Yarns include closely associated bundles of twisted filaments. Each filament diameter in a yarn is relatively uniform. Yarns have varying weights described by their ‘tex,’ expressed as weight in grams of 1000 linear meters, or denier, expressed as weight in pounds of 10,000 yards, with a typical tex range usually being between about 200 tex to about 2000 tex.

Tows include loosely associated bundles of untwisted filaments. As in yarns, filament diameter in a tow is generally uniform. Tows also have varying weights and the tex range is usually between 200 tex and 2000 tex. They are frequently characterized by the number of thousands of filaments in the tow, for example 12K tow, 24K tow, 48K tow, and the like.

Carbon tapes are materials that can be assembled as weaves or can represent non-woven flattened tows. Carbon tapes can vary in width and are generally two-sided structures similar to ribbon. Processes of the present invention are compatible with CNT infusion on one or both sides of a tape. CNT-infused tapes can resemble a “carpet” or “forest” on a flat substrate surface. Again, processes described herein can be performed in a continuous mode to functionalize spools of tape.

Carbon fiber-braids represent rope-like structures of densely packed carbon fibers. Such structures can be assembled from carbon yarns, for example. Braided structures can include a hollow portion or a braided structure can be assembled about another core material.

In some embodiments a number of primary carbon fiber material structures can be organized into fabric or sheet-like structures. These include, for example, woven carbon fabrics, non-woven carbon fiber mat and carbon fiber ply, in addition to the tapes described above. Such higher ordered structures can be assembled from parent tows, yarns, filaments or the like, with CNTs already infused in the parent fiber. Alternatively such structures can serve as the substrate for the CNT infusion processes described herein.

There are three types of carbon fiber which are categorized based on the precursors used to generate the fibers, any of which can be used in the invention: Rayon, Polyacrylonitrile (PAN) and Pitch. Carbon fiber from rayon precursors, which are cellulosic materials, has relatively low carbon content at about 20% and the fibers tend to have low strength and stiffness. Polyacrylonitrile (PAN) precursors provide a carbon fiber with a carbon content of about 55%. Carbon fiber based on a PAN precursor generally has a higher tensile strength than carbon fiber based on other carbon fiber precursors due to a minimum of surface defects.

Pitch precursors based on petroleum asphalt, coal tar, and polyvinyl chloride can also be used to produce carbon fiber. Although pitches are relatively low in cost and high in carbon yield, there can be issues of non-uniformity in a given batch.

CNTs useful for infusion to carbon fiber materials include single-walled CNTs, double-walled CNTs, multi-walled CNTs, and mixtures thereof. The exact CNTs to be used depends on the application of the CNT-infused carbon fiber. CNTs can be used for thermal and/or electrical conductivity applications, or as insulators. In some embodiments, the infused carbon nanotubes are single-wall nanotubes. In some embodiments, the infused carbon nanotubes are multi-wall nanotubes. In some embodiments, the infused carbon nanotubes are a combination of single-wall and multi-wall nanotubes. There are some differences in the characteristic properties of single-wall and multi-wall nanotubes that, for some end uses of the fiber, dictate the synthesis of one or the other type of nanotube. For example, single-walled nanotubes can be semi-conducting or metallic, while multi-walled nanotubes are metallic.

CNTs lend their characteristic properties such as mechanical strength, low to moderate electrical resistivity, high thermal conductivity, and the like to the CNT-infused carbon fiber material. For example, in some embodiments, the electrical resistivity of a carbon nanotube-infused carbon fiber material is lower than the electrical resistivity of a parent carbon fiber material. More generally, the extent to which the resulting CNT-infused fiber expresses these characteristics can be a function of the extent and density of coverage of the carbon fiber by the carbon nanotubes. Any amount of the fiber surface area, from 0-55% of the fiber can be covered assuming an 8 nm diameter, 5-walled MWNT (again this calculation counts the space inside the CNTs as Tillable). This number is lower for smaller diameter CNTs and more for greater diameter CNTs. 55% surface area coverage is equivalent to about 15,000 CNTs/μm². Further CNT properties can be imparted to the carbon fiber material in a manner dependent on CNT length, as described above. Infused CNTs can vary in length ranging from between about 1 micron to about 500 microns, including 1 micron, 2 microns, 3 microns, 4 micron, 5, microns, 6, microns, 7 microns, 8 microns, 9 microns, 10 microns, 15 microns, 20 microns, 25 microns, 30 microns, 35 microns, 40 microns, 45 microns, 50 microns, 60 microns, 70 microns, 80 microns, 90 microns, 100 microns, 150 microns, 200 microns, 250 microns, 300 microns, 350 microns, 400 microns, 450 microns, 500 microns, and all values in between. CNTs can also be less than about 1 micron in length, including about 0.5 microns, for example. CNTs can also be greater than 500 microns in length, including, for example, 510 microns, 520 microns, 550 microns, 600 microns, 700 microns and all values in between.

Compositions described herein can incorporate CNTs have a length from about 1 micron to about 10 microns. Such CNT lengths can be useful in applications to increase shear strength. CNTs can also have a length from about 5 to about 70 microns. Such CNT lengths can be useful in applications for increased tensile strength if the CNTs are aligned in the fiber direction. CNTs can also have a length from about 10 microns to about 100 microns. Such CNT lengths can be useful to increase electrical/thermal properties as well as mechanical properties. The process described herein can also provide CNTs having a length from about 100 microns to about 500 microns, which can also be beneficial to increase electrical and thermal properties. Such control of CNT length is readily achieved through modulation of carbon feedstock and inert gas flow rates coupled with varying linespeeds and growth temperature.

In some embodiments, compositions that include spoolable lengths of CNT-infused carbon fiber materials can have various uniform regions with different lengths of CNTs. For example, it can be desirable to have a first portion of CNT-infused carbon fiber material with uniformly shorter CNT lengths to enhance shear strength properties, and a second portion of the same spoolable material with a uniform longer CNT length to enhance electrical or thermal properties.

Processes for CNT infusion to carbon fiber materials allow control of the CNT lengths with uniformity and in a continuous process allowing spoolable carbon fiber materials to be functionalized with CNTs at high rates. With material residence times between 5 to 300 seconds, linespeeds in a continuous process for a system that is 3 feet long can be in a range anywhere from about 0.5 ft/min to about 36 ft/min and greater. The speed selected depends on various parameters as explained further below.

In some embodiments, a material residence time of about 5 to about 30 seconds can produce CNTs having a length between about 1 micron to about 10 microns. In some embodiments, a material residence time of about 30 to about 180 seconds can produce CNTs having a length between about 10 microns to about 100 microns. In still further embodiments, a material residence time of about 180 to about 300 seconds can produce CNTs having a length between about 100 microns to about 500 microns. One skilled in the art will recognize that these ranges are approximate and that CNT length can also be modulated by reaction temperatures, and carrier and carbon feedstock concentrations and flow rates.

CNT-infused carbon fiber materials of the invention include a barrier coating. Barrier coatings can include for example an alkoxysilane, methylsiloxane, an alumoxane, alumina nanoparticles, spin on glass and glass nanoparticles. As described below, the CNT-forming catalyst can be added to the uncured barrier coating material and then applied to the carbon fiber material together. In other embodiments the barrier coating material can be added to the carbon fiber material prior to deposition of the CNT-forming catalyst. The barrier coating material can be of a thickness sufficiently thin to allow exposure of the CNT-forming catalyst to the carbon feedstock for subsequent CVD growth. In some embodiments, the thickness is less than or about equal to the effective diameter of the CNT-forming catalyst. In some embodiments, the thickness of the barrier coating is in a range from between about 10 nm to about 100 nm. The barrier coating can also be less than 10 nm, including 1 nm, 2 nm, 3 nm, 4 nm, 5 nm, 6 nm, 7 nm, 8 nm, 9 nm, 10 nm, and any value in between.

Without being bound by theory, the barrier coating can serve as an intermediate layer between the carbon fiber material and the CNTs and serves to mechanically infuse the CNTs to the carbon fiber material. Such mechanical infusion still provides a robust system in which the carbon fiber material serves as a platform for organizing the CNTs while still imparting properties of the CNTs to the carbon fiber material. Moreover, the benefit of including a bather coating is the immediate protection it provides the carbon fiber material from chemical damage due to exposure to moisture and/or any thermal damage due to heating of the carbon fiber material at the temperatures used to promote CNT growth.

The infused CNTs disclosed herein can effectively function as a replacement for conventional carbon fiber “sizing.” The infused CNTs are more robust than conventional sizing materials and can improve the fiber-to-matrix interface in composite materials and, more generally, improve fiber-to-fiber interfaces. Indeed, the CNT-infused carbon fiber materials disclosed herein are themselves composite materials in the sense the CNT-infused carbon fiber material properties will be a combination of those of the carbon fiber material as well as those of the infused CNTs. Consequently, embodiments of the present invention provide a means to impart desired properties to a carbon fiber material that otherwise lack such properties or possesses them in insufficient measure, Carbon fiber materials can be tailored or engineered to meet the requirements of specific applications. The CNTs acting as sizing can protect carbon fiber materials from absorbing moisture due to the hydrophobic CNT structure. Moreover, hydrophobic matrix materials, as further exemplified below, interact well with hydrophobic CNTs to provide improved fiber to matrix interactions.

In some embodiments the present disclosure provides a continuous process for CNT infusion that includes (a) disposing a carbon nanotube-forming catalyst on a surface of a carbon fiber material of spoolable dimensions; and (b) synthesizing carbon nanotubes directly on the carbon fiber material, thereby forming a carbon nanotube-infused carbon fiber material. For a 9 foot long system, the linespeed of the process can range from between about 1.5 ft/min to about 108 ft/min. The linespeeds achieved by the process described herein allow the formation of commercially relevant quantities of CNT-infused carbon fiber materials with short production times. For example, at 36 ft/min linespeed, the quantities of CNT-infused carbon fibers (over 5% infused CNTs on fiber by weight) can exceed over 100 pound or more of material produced per day in a system that is designed to simultaneously process 5 separate tows (20 lb/tow). Systems can be made to produce more tows at once or at faster speeds by repeating growth zones. Moreover, some steps in the fabrication of CNTs, as known in the art, have prohibitively slow rates preventing a continuous mode of operation. For example, in a typical process known in the art, a CNT-forming catalyst reduction step can take 1-12 hours to perform. CNT growth itself can also be time consuming, for example requiring tens of minutes for CNT growth, precluding the rapid linespeeds realized in the present invention. The process described herein overcomes such rate limiting steps.

The CNT-infused carbon fiber material-forming processes of the invention can avoid high degrees CNT entanglement that occurs when trying to apply suspensions of pre-formed carbon nanotubes to fiber materials. That is, because pre-formed CNTs are not fused to the carbon fiber material, the CNTs tend to bundle and entangle. The result is a poorly uniform distribution of CNTs that weakly adhere to the carbon fiber material. However, processes of the present invention can provide, if desired, a highly uniform entangled CNT mat on the surface of the carbon fiber material by reducing the growth density. The CNTs grown at low density are infused in the carbon fiber material first. In such embodiments, the fibers do not grow dense enough to induce vertical alignment, the result is entangled mats on the carbon fiber material surfaces. By contrast, manual application of pre-formed CNTs does not insure uniform distribution and density of a CNT mat on the carbon fiber material.

To infuse carbon nanotubes into a carbon fiber material, the carbon nanotubes are synthesized on the carbon fiber material which is conformally coated with a barrier coating. In one embodiment, this is accomplished by first conformally coating the carbon fiber material with a barrier coating and then disposing nanotube-forming catalyst on the barrier coating. In some embodiments, the barrier coating can be partially cured prior to catalyst deposition. This can provide a surface that is receptive to receiving the catalyst and allowing it to embed in the barrier coating, including allowing surface contact between the CNT forming catalyst and the carbon fiber material. In such embodiments, the barrier coating can be fully cured after embedding the catalyst. In some embodiments, the barrier coating is conformally coated over the carbon fiber material simultaneously with deposition of the CNT-form catalyst. Once the CNT-forming catalyst and barrier coating are in place, the barrier coating can be fully cured.

In some embodiments, the barrier coating can be fully cured prior to catalyst deposition. In such embodiments, a fully cured barrier-coated carbon fiber material can be treated with a plasma to prepare the surface to accept the catalyst. For example, a plasma treated carbon fiber material having a cured barrier coating can provide a roughened surface in which the CNT-forming catalyst can be deposited. The plasma process for “roughing” the surface of the barrier thus facilitates catalyst deposition. The roughness is typically on the scale of nanometers. In the plasma treatment process craters or depressions are formed that are nanometers deep and nanometers in diameter. Such surface modification can be achieved using a plasma of any one or more of a variety of different gases, including, without limitation, argon, helium, oxygen, nitrogen, and hydrogen. In some embodiments, plasma roughing can also be performed directly in the carbon fiber material itself. This can facilitate adhesion of the barrier coating to the carbon fiber material.

As described further below the catalyst can be prepared as a liquid solution that contains CNT-forming catalyst that comprise transition metal nanoparticles. The diameters of the synthesized nanotubes are related to the size of the metal particles as described above. In some embodiments, commercial dispersions of CNT-forming transition metal nanoparticle catalyst are available and are used without dilution, in other embodiments commercial dispersions of catalyst can be diluted. Whether to dilute such solutions can depend on the desired density and length of CNT to be grown as described above.

Carbon nanotube synthesis can be based on a chemical vapor deposition (CVD) process and occurs at elevated temperatures. The specific temperature is a function of catalyst choice, but will typically be in a range of about 500° C. to 1000° C. This operation involves heating the barrier-coated carbon fiber material to a temperature in the aforementioned range to support carbon nanotube synthesis.

CVD-promoted nanotube growth on the catalyst-laden carbon fiber material is then performed. The CVD process can be promoted by, for example, a carbon-containing feedstock gas such as acetylene, ethylene, and/or ethanol. The CNT synthesis processes generally use an inert gas (nitrogen, argon, helium) as a primary carrier gas. The carbon feedstock is provided in a range from between about 0% to about 15% of the total mixture. A substantially inert environment for CVD growth is prepared by removal of moisture and oxygen from the growth chamber.

In the CNT synthesis process, CNTs grow at the sites of a CNT-forming transition metal nanoparticle catalyst. The presence of the strong plasma-creating electric field can be optionally employed to affect nanotube growth. That is, the growth tends to follow the direction of the electric field. By properly adjusting the geometry of the plasma spray and electric field, vertically-aligned CNTs (i.e., perpendicular to the carbon fiber material) can be synthesized. Under certain conditions, even in the absence of a plasma, closely-spaced nanotubes will maintain a vertical growth direction resulting in a dense array of CNTs resembling a carpet or forest. The presence of the barrier coating can also influence the directionality of CNT growth.

The operation of disposing a catalyst on the carbon fiber material can be accomplished by spraying or dip coating a solution or by gas phase deposition via, for example, a plasma process. The choice of techniques can be coordinated with the mode with which the barrier coating is applied. Thus, in some embodiments, after forming a solution of a catalyst in a solvent, catalyst can be applied by spraying or dip coating the barrier coated carbon fiber material with the solution, or combinations of spraying and dip coating. Either technique, used alone or in combination, can be employed once, twice, thrice, four times, up to any number of times to provide a carbon fiber material that is sufficiently uniformly coated with CNT-forming catalyst. When dip coating is employed, for example, a carbon fiber material can be placed in a first dip bath for a first residence time in the first dip bath. When employing a second dip bath, the carbon fiber material can be placed in the second dip bath for a second residence time. For example, carbon fiber materials can be subjected to a solution of CNT-forming catalyst for between about 3 seconds to about 90 seconds depending on the dip configuration and linespeed. Employing spraying or dip coating processes, a carbon fiber material with a surface density of catalyst of less than about 5% surface coverage to as high as about 80% coverage, in which the CNT-forming catalyst nanoparticles are nearly monolayer. In some embodiments, the process of coating the CNT-forming catalyst on the carbon fiber material should produce no more than a monolayer. For example, CNT growth on a stack of CNT-forming catalyst can erode the degree of infusion of the CNT to the carbon fiber material. In other embodiments, the transition metal catalyst can be deposited on the carbon fiber material using evaporation techniques, electrolytic deposition techniques, and other processes known to those skilled in the art, such as addition of the transition metal catalyst to a plasma feedstock gas as a metal organic, metal salt or other composition promoting gas phase transport.

Because processes of the invention are designed to be continuous, a spoolable carbon fiber material can be dip-coated in a series of baths where dip coating baths are spatially separated. In a continuous process in which nascent carbon fibers are being generated de novo, dip bath or spraying of CNT-forming catalyst can be the first step after applying and curing or partially curing a barrier coating to the carbon fiber material. Application of the barrier coating and a CNT-forming catalyst can be performed in lieu of application of a sizing, for newly formed carbon fiber materials. In other embodiments, the CNT-forming catalyst can be applied to newly formed carbon fibers in the presence of other sizing agents after barrier coating. Such simultaneous application of CNT-forming catalyst and other sizing agents can still provide the CNT-forming catalyst in surface contact with the barrier coating of the carbon fiber material to insure CNT infusion.

The catalyst solution employed can be a transition metal nanoparticle which can be any d-block transition metal as described above. In addition, the nanoparticles can include alloys and non-alloy mixtures of d-block metals in elemental form or in salt form, and mixtures thereof. Such salt forms include, without limitation, oxides, carbides, and nitrides. Non-limiting exemplary transition metal NPs include Ni, Fe, Co, Mo, Cu, Pt, Au, and Ag and salts thereof and mixtures thereof. In some embodiments, such CNT-forming catalysts are disposed on the carbon fiber by applying or infusing a CNT-forming catalyst directly to the carbon fiber material simultaneously with barrier coating deposition. Many of these transition metal catalysts are readily commercially available from a variety of suppliers, including, for example, Ferrotec Corporation (Bedford, N.H.).

Catalyst solutions used for applying the CNT-forming catalyst to the carbon fiber material can be in any common solvent that allows the CNT-forming catalyst to be uniformly dispersed throughout. Such solvents can include, without limitation, water, acetone, hexane, isopropyl alcohol, toluene, ethanol, methanol, tetrahydrofuran (THF), cyclohexane or any other solvent with controlled polarity to create an appropriate dispersion of the CNT-forming catalyst nanoparticles. Concentrations of CNT-forming catalyst can be in a range from about 1:1 to 1:10000 catalyst to solvent. Such concentrations can be used when the barrier coating and CNT-forming catalyst is applied simultaneously as well.

In some embodiments heating of the carbon fiber material can be at a temperature that is between about 500° C. and 1000° C. to synthesize carbon nanotubes after deposition of the CNT-forming catalyst. Heating at these temperatures can be performed prior to or substantially simultaneously with introduction of a carbon feedstock for CNT growth.

In some embodiments, the present invention provides a process that includes removing sizing agents from a carbon fiber material, applying a barrier coating conformally over the carbon fiber material, applying a CNT-forming catalyst to the carbon fiber material, heating the carbon fiber material to at least 500° C., and synthesizing carbon nanotubes on the carbon fiber material. In some embodiments, operations of the CNT-infusion process include removing sizing from a carbon fiber material, applying a barrier coating to the carbon fiber material, applying a CNT-forming catalyst to the carbon fiber, heating the fiber to CNT-synthesis temperature and CVD-promoted CNT growth the catalyst-laden carbon fiber material. Thus, where commercial carbon fiber materials are employed, processes for constructing CNT-infused carbon fibers can include a discrete step of removing sizing from the carbon fiber material before disposing barrier coating and the catalyst on the carbon fiber material.

The step of synthesizing carbon nanotubes can include numerous techniques for forming carbon nanotubes, including those disclosed in co-pending U.S. Patent Application No. US 2004/0245088 which is incorporated herein by reference. The CNTs grown on fibers of the present invention can be accomplished by techniques known in the art including, without limitation, micro-cavity, thermal or plasma-enhanced CVD techniques, laser ablation, arc discharge, and high pressure carbon monoxide (HiPCO). During CVD, in particular, a barrier coated carbon fiber material with CNT-forming catalyst disposed thereon, can be used directly. In some embodiments, any conventional sizing agents can be removed prior CNT synthesis. In some embodiments, acetylene gas is ionized to create a jet of cold carbon plasma for CNT synthesis. The plasma is directed toward the catalyst-bearing carbon fiber material. Thus, in some embodiments synthesizing CNTs on a carbon fiber material includes (a) forming a carbon plasma; and (b) directing the carbon plasma onto the catalyst disposed on the carbon fiber material. The diameters of the CNTs that are grown are dictated by the size of the CNT-forming catalyst as described above. In some embodiments, the sized fiber substrate is heated to between about 550° C. to about 800° C. to facilitate CNT synthesis. To initiate the growth of CNTs, two gases are bled into the reactor: a process gas such as argon, helium, or nitrogen, and a carbon-containing gas, such as acetylene, ethylene, ethanol or methane. CNTs grow at the sites of the CNT-forming catalyst.

In some embodiments, the CVD growth is plasma-enhanced. A plasma can be generated by providing an electric field during the growth process. CNTs grown under these conditions can follow the direction of the electric field. Thus, by adjusting the geometry of the reactor vertically aligned carbon nanotubes can be grown radially about a cylindrical fiber. In some embodiments, a plasma is not required for radial growth about the fiber. For carbon fiber materials that have distinct sides such as tapes, mats, fabrics, plies, and the like, catalyst can be disposed on one or both sides and correspondingly, CNTs can be grown on one or both sides as well.

As described above, CNT-synthesis is performed at a rate sufficient to provide a continuous process for functionalizing spoolable carbon fiber materials. Numerous apparatus configurations facilitate such continuous synthesis as exemplified below.

Another configuration for continuous carbon nanotube synthesis involves a special rectangular or optimally shaped reactor for the synthesis and growth of carbon nanotubes directly on carbon fiber materials. The reactor can be designed for use in a continuous in-line process for producing carbon-nanotube bearing fibers. In some embodiments, CNTs are grown via a chemical vapor deposition (“CVD”) process at atmospheric pressure and at elevated temperature in the range of about 550° C. to about 800° C. in a multi-zone reactor. The fact that the synthesis occurs at atmospheric pressure is one factor that facilitates the incorporation of the reactor into a continuous processing line for CNT-on-fiber synthesis. Another advantage consistent with in-line continuous processing using such a zone reactor is that CNT growth occurs in a seconds, as opposed to minutes (or longer) as in other procedures and apparatus configurations typical in the art.

CNT synthesis reactors in accordance with the various embodiments include the following features:

Optimally Shaped Synthesis Reactors: The cross section of a typical CNT synthesis reactor used in the art is circular. There are a number of reasons for this including, for example, historical reasons (cylindrical reactors are often used in laboratories) and convenience (flow dynamics are easy to model in cylindrical reactors, heater systems readily accept circular tubes (quartz, etc.), and ease of manufacturing. Departing from the cylindrical convention, the present invention provides a CNT synthesis reactor having a rectangular cross section or other optimally shaped cross section. The reasons for the departure are as follows: 1. Since many carbon fiber materials that can be processed by the reactor are relatively planar such as flat tape or sheet-like in form, a circular cross section is an inefficient use of the reactor volume. This inefficiency results in several drawbacks for cylindrical CNT synthesis reactors including, for example, a) maintaining a sufficient system purge; increased reactor volume requires increased gas flow rates to maintain the same level of gas purge. This results in a system that is inefficient for high volume production of CNTs in an open environment; b) increased carbon feedstock gas flow; the relative increase in inert gas flow, as per a) above, requires increased carbon feedstock gas flows. Consider that the volume of a 12K carbon fiber tow is 2000 times less than the total volume of a synthesis reactor having a rectangular cross section. In an equivalent growth cylindrical reactor (i.e., a cylindrical reactor that has a width that accommodates the same planarized carbon fiber material as the rectangular cross-section reactor), the volume of the carbon fiber material is 17,500 times less than the volume of the chamber.

Although gas deposition processes, such as CVD, are typically governed by pressure and temperature alone, volume has a significant impact on the efficiency of deposition. With a rectangular reactor and other shaped reactors there is still excess volume. This excess volume facilitates unwanted reactions; yet a cylindrical reactor has about eight times that volume. Due to this greater opportunity for competing reactions to occur, the desired reactions effectively occur more slowly in a cylindrical reactor chamber. Such a slow down in CNT growth, is problematic for the development of a continuous process. One benefit of a rectangular or other shaped reactor configuration is that the reactor volume can be decreased by using a small height for the rectangular or other optimally shaped chamber to make this volume ratio better and reactions more efficient. In some embodiments of the present invention, the total volume of a synthesis reactor is no more than about 3000 times greater than the total volume of a carbon fiber material being passed through the synthesis reactor. In some further embodiments, the total volume of the synthesis reactor is no more than about 4000 times greater than the total volume of the carbon fiber material being passed through the synthesis reactor. In some still further embodiments, the total volume of the synthesis reactor is less than about 10,000 times greater than the total volume of the carbon fiber material being passed through the synthesis reactor. Additionally, it is notable that when using a cylindrical reactor, more carbon feedstock gas is required to provide the same flow percent as compared to other reactors. It should be appreciated that in some embodiments, the synthesis reactor has a cross section that is described by polygonal forms that are not rectangular, but are relatively similar thereto and provide a similar reduction in reactor volume relative to a reactor having a circular cross section; c) problematic temperature distribution; when a relatively small-diameter reactor is used, the temperature gradient from the center of the chamber to the walls thereof is minimal. But with increased size, such as would be used for commercial-scale production, the temperature gradient increases. Such temperature gradients result in product quality variations across a carbon fiber material substrate (i.e., product quality varies as a function of radial position). This problem is substantially avoided when using a reactor having a rectangular cross section. In particular, when a planar substrate is used, reactor height can be maintained constant as the size of the substrate scales upward. Temperature gradients between the top and bottom of the reactor are essentially negligible and, as a consequence, thermal issues and the product-quality variations that result are avoided. 2. Gas introduction: Because tubular furnaces are normally employed in the art, typical CNT synthesis reactors introduce gas at one end and draw it through the reactor to the other end. In some embodiments disclosed herein, gas can be introduced at the center of the reactor or within a target growth zone, symmetrically, either through the sides or through the top and bottom plates of the reactor. This improves the overall CNT growth rate because the incoming feedstock gas is continuously replenishing at the hottest portion of the system, which is where CNT growth is most active. This constant gas replenishment is an important aspect to the increased growth rate exhibited by the rectangular CNT reactors.

Zoning. Chambers that provide a relatively cool purge zone depend from both ends of the rectangular synthesis reactor. Applicants have determined that if hot gas were to mix with the external environment (i.e., outside of the reactor), there would be an increase in degradation of the carbon fiber material. The cool purge zones provide a buffer between the internal system and external environments. Typical CNT synthesis reactor configurations known in the art typically require that the substrate is carefully (and slowly) cooled. The cool purge zone at the exit of the present rectangular or other shaped CNT growth reactor achieves the cooling in a short period of time, as required for the continuous in-line processing.

Non-contact, hot-walled, metallic reactor. In some embodiments, a hot-walled reactor is made of metal is employed, in particular stainless steel. This may appear counterintuitive because metal, and stainless steel in particular, is more susceptible to carbon deposition (i.e., soot and by-product formation). Thus, most CNT reactor configurations use quartz reactors because there is less carbon deposited, quartz is easier to clean, and quartz facilitates sample observation.

However, it has been observed that the increased soot and carbon deposition on stainless steel results in more consistent, faster, more efficient, and more stable CNT growth. Without being bound by theory it has been indicated that, in conjunction with atmospheric operation, the CVD process occurring in the reactor is diffusion limited. That is, the catalyst is “overfed;” too much carbon is available in the reactor system due to its relatively higher partial pressure (than if the reactor was operating under partial vacuum). As a consequence, in an open system—especially a clean one—too much carbon can adhere to catalyst particles, compromising their ability to synthesize CNTs. In some embodiments, the rectangular reactor is intentionally run when the reactor is “dirty,” that is with soot deposited on the metallic reactor walls. Once carbon deposits to a monolayer on the walls of the reactor, carbon will readily deposit over itself. Since some of the available carbon is “withdrawn” due to this mechanism, the remaining carbon feedstock, in the form of radicals, react with the catalyst at a rate that does not poison the catalyst. Existing systems run “cleanly” which, if they were open for continuous processing, would produce a much lower yield of CNTs at reduced growth rates.

Although it is generally beneficial to perform CNT synthesis “dirty” as described above, certain portions of the apparatus, such as gas manifolds and inlets, can nonetheless negatively impact the CNT growth process when soot created blockages. In order to combat this problem, such areas of the CNT growth reaction chamber can be protected with soot inhibiting coatings such as silica, alumina, or MgO. In practice, these portions of the apparatus can be dip-coated in these soot inhibiting coatings. Metals such as INVAR® can be used with these coatings as INVAR has a similar CTE (coefficient of thermal expansion) ensuring proper adhesion of the coating at higher temperatures, preventing the soot from significantly building up in critical zones. In some embodiments, low reactivity “sleeves” can be inserted into the metal reactor to prevent reactive gas to reactor wall interactions, which can cause excessive soot formation and decreased process efficiency.

Combined Catalyst Reduction and CNT Synthesis. In the CNT synthesis reactor disclosed herein, both catalyst reduction and CNT growth occur within the reactor. This is significant because the reduction step cannot be accomplished timely enough for use in a continuous process if performed as a discrete operation. In a typical process known in the art, a reduction step typically takes 1-12 hours to perform. Both operations occur in a reactor in accordance with the present invention due, at least in part, to the fact that carbon feedstock gas is introduced at the center of the reactor, not the end as would be typical in the art using cylindrical reactors. The reduction process occurs as the fibers enter the heated zone; by this point, the gas has had time to react with the walls and cool off prior to reacting with the catalyst and causing the oxidation reduction (via hydrogen radical interactions). It is this transition region where the reduction occurs. At the hottest isothermal zone in the system, the CNT growth occurs, with the greatest growth rate occurring proximal to the gas inlets near the center of the reactor.

In some embodiments, when loosely affiliated carbon fiber materials, such as carbon tow are employed, the continuous process can include steps that spreads out the strands and/or filaments of the tow. Thus, as a tow is unspooled it can be spread using a vacuum-based fiber spreading system, for example. When employing sized carbon fibers, which can be relatively stiff, additional heating can be employed in order to “soften” the tow to facilitate fiber spreading. The spread fibers which comprise individual filaments can be spread apart sufficiently to expose an entire surface area of the filaments, thus allowing the tow to more efficiently react in subsequent process steps. Such spreading can approach between about 4 inches to about 6 inches across for a 3k tow. The spread carbon tow can pass through a surface treatment step that is composed of a plasma system as described above. After a barrier coating is applied and roughened, spread fibers then can pass through a CNT-forming catalyst dip bath. The result is fibers of the carbon tow that have catalyst particles distributed radially on their surface. The catalyzed-laden fibers of the tow then enter an appropriate CNT growth chamber, such as the rectangular chamber described above, where a flow through atmospheric pressure CVD or PE-CVD process is used to synthesize the CNTs at rates as high as several microns per second. The fibers of the tow, now with radially aligned CNTs, exit the CNT growth reactor.

In some embodiments, CNT-infused carbon fiber materials can pass through yet another treatment process that, in some embodiments is a plasma process used to functionalize the CNTs. Additional functionalization of CNTs can be used to promote their adhesion to particular resins. Thus, in some embodiments, the present invention provides CNT-infused carbon fiber materials having functionalized CNTs.

As part of the continuous processing of spoolable carbon fiber materials, the CNT-infused carbon fiber material can further pass through a sizing dip bath to apply any additional sizing agents which can be beneficial in a final product. Finally if wet winding is desired, the CNT-infused carbon fiber materials can be passed through a resin bath and wound on a mandrel or spool. The resulting carbon fiber material/resin combination locks the CNTs on the carbon fiber material allowing for easier handling and composite fabrication. In some embodiments, CNT infusion is used to provide improved filament winding. Thus, CNTs formed on carbon fibers such as carbon tow, are passed through a resin bath to produce resin-impregnated, CNT-infused carbon tow. After resin impregnation, the carbon tow can be positioned on the surface of a rotating mandrel by a delivery head. The tow can then be wound onto the mandrel in a precise geometric pattern in known fashion.

The winding process described above provides pipes, tubes, or other forms as are characteristically produced via a male mold. But the forms made from the winding process disclosed herein differ from those produced via conventional filament winding processes.

Specifically, in the process disclosed herein, the forms are made from composite materials that include CNT-infused tow. Such forms will therefore benefit from enhanced strength and the like, as provided by the CNT-infused tow.

In some embodiments, a continuous process for infusion of CNTs on spoolable carbon fiber materials can achieve a linespeed between about 0.5 ft/min to about 36 ft/min. In this embodiment where the CNT growth chamber is 3 feet long and operating at a 750° C. growth temperature, the process can be run with a linespeed of about 6 ft/min to about 36 ft/min to produce, for example, CNTs having a length between about 1 micron to about 10 microns. The process can also be run with a linespeed of about 1 ft/min to about 6 ft/min to produce, for example, CNTs having a length between about 10 microns to about 100 microns. The process can be run with a linespeed of about 0.5 ft/min to about 1 ft/min to produce, for example, CNTs having a length between about 100 microns to about 200 microns. The CNT length is not tied only to linespeed and growth temperature, however, the flow rate of both the carbon feedstock and the inert carrier gases can also influence CNT length. For example, a flow rate consisting of less than 1% carbon feedstock in inert gas at high linespeeds (6 ft/min to 36 ft/min) will result in CNTs having a length between 1 micron to about 5 microns. A flow rate consisting of more than 1% carbon feedstock in inert gas at high linespeeds (6 ft/min to 36 ft/min) will result in CNTs having length between 5 microns to about 10 microns.

In some embodiments, more than one carbon material can be run simultaneously through the process. For example, multiple tapes tows, filaments, strand and the like can be run through the process in parallel. Thus, any number of pre-fabricated spools of carbon fiber material can be run in parallel through the process and re-spooled at the end of the process. The number of spooled carbon fiber materials that can be run in parallel can include one, two, three, four, five, six, up to any number that can be accommodated by the width of the CNT-growth reaction chamber. Moreover, when multiple carbon fiber materials are run through the process, the number of collection spools can be less than the number of spools at the start of the process. In such embodiments, carbon strands, tows, or the like can be sent through a further process of combining such carbon fiber materials into higher ordered carbon fiber materials such as woven fabrics or the like. The continuous process can also incorporate a post processing chopper that facilitates the formation CNT-infused chopped fiber mats, for example.

In some embodiments, processes of the invention allow for synthesizing a first amount of a first type of carbon nanotube on the carbon fiber material, in which the first type of carbon nanotube is selected to alter at least one first property of the carbon fiber material. Subsequently, process of the invention allow for synthesizing a second amount of a second type of carbon nanotube on the carbon fiber material, in which the second type of carbon nanotube is selected to alter at least one second property of the carbon fiber material.

In some embodiments, the first amount and second amount of CNTs are different. This can be accompanied by a change in the CNT type or not. Thus, varying the density of CNTs can be used to alter the properties of the original carbon fiber material, even if the CNT type remains unchanged. CNT type can include CNT length and the number of walls, for example. In some embodiments the first amount and the second amount are the same. If different properties are desirable in this case along the two different stretches of the spoolable material, then the CNT type can be changed, such as the CNT length. For example, longer CNTs can be useful in electrical/thermal applications, while shorter CNTs can be useful in mechanical strengthening applications.

Electrical conductivity or specific conductance is a measure of a material's ability to conduct an electric current. CNTs with particular structural parameters such as the degree of twist, which relates to CNT chirality, can be highly conducting, thus exhibiting metallic properties. A recognized system of nomenclature (M. S. Dresselhaus, et al. Science of Fullerenes and Carbon Nanotubes, Academic Press, San Diego, Calif. pp. 756-760, (1996)) has been formalized and is recognized by those skilled in the art with respect to CNT chirality. Thus, for example, CNTs are distinguished from each other by a double index (n,m) where n and m are integers that describe the cut and wrapping of hexagonal graphite so that it makes a tube when it is wrapped onto the surface of a cylinder and the edges are sealed together. When the two indices are the same, m=n, the resultant tube is said to be of the “arm-chair” (or n,n) type, since when the tube is cut perpendicular to the CNT axis only the sides of the hexagons are exposed and their pattern around the periphery of the tube edge resembles the arm and seat of an arm chair repeated n times. Arm-chair CNTs, in particular SWNTs, are metallic, and have extremely high electrical and thermal conductivity. In addition, such SWNTs have-extremely high tensile strength.

In addition to the degree of twist, CNT diameter also effects electrical conductivity. As described above, CNT diameter can be controlled by use of controlled size CNT-forming catalyst nanoparticles. CNTs can also be formed as semi-conducting materials. Conductivity in multi-walled CNTs (MWNTs) can be more complex. Interwall reactions within MWNTs can redistribute current over individual tubes non-uniformly. By contrast, there is no change in current across different parts of metallic single-walled nanotubes (SWNTs). Carbon nanotubes also have very high thermal conductivity, comparable to diamond crystal and in-plane graphite sheet.

The CNT-infused carbon fiber materials can benefit from the presence of CNTs not only in the properties described above, but can also provide lighter materials in the process. Thus, such lower density and higher strength materials translates to greater strength to weight ratio.

To facilitate a better understanding of the embodiments described herein, the following experimental examples are provided. The examples are provided for purposes of illustration only and should be considered non-limiting

### EXAMPLES

### Example 1

### Analyses of Carbon Nanostructure-Infused Fibers Using Imaging Techniques

Seven carbon nanostructure-infused glass fiber tows were prepared as set forth in the foregoing description, and the weight percentages of carbon nanostructures thereon was determined by LOI methods. The experimentally determined LOI measurements for each fiber are set forth in Table 1. Visual images of the fibers were also obtained using the imaging configuration shown in FIG. 3, and based on the pixel count of each image (for instance, see FIG. 5), the calculated LOI values were determined using the correlation function shown in FIG. 6. As shown in Table 1, the calculated LOI values compared very favorably to the experimentally determined LOI values, typically having a relative error of less than 4.5%. Absolute LOI error was determined by subtracting the actual LOT value from the calculated LOT value and taking the absolute value.

TABLE 1

| | | Calculated | | Relative |
|---|---|---|---|---|
| | | LOI by | Absolute | LOI |
| | Actual | Correlation | LOI | Error |
| Sample # | LOI (%) | Function (%) | Error (%) | (%) |
| 1 | 31.22 | 31.68 | 0.46 | 1.47 |
| 2 | 31.58 | 32.19 | 0.61 | 1.94 |
| 3 | 31.42 | 32.11 | 0.69 | 2.21 |
| 4 | 31.35 | 31.58 | 0.23 | 0.74 |
| 5 | 30.92 | 31.19 | 0.27 | 0.86 |
| 6 | 30.60 | 31.97 | 1.37 | 4.48 |
| 7 | 30.41 | 31.09 | 0.68 | 2.25 |
| | | AVERAGE | ±0.62 | ±1.99 |

Although the invention has been described with reference to the disclosed embodiments, those skilled in the art will readily appreciate that these are only illustrative of the invention. It should be understood that various modifications can be made without departing from the spirit of the invention. The invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

What is claimed is the following:

1. A method comprising:
providing a plurality of carbon nanostructures infused to a substrate;
acquiring an image of the plurality of carbon nanostructures while they are infused to the substrate;
converting the image of the plurality of carbon nanostructures into a binary image, the binary image comprising a carbon nanostructure/substrate portion and an extraneous portion; and
correlating the carbon nanostructure/substrate portion of the binary image with an amount of carbon nanostructures infused to the substrate.

2. The method of claim 1, wherein the image comprises a visible light image.

3. The method of claim 1, further comprising:
identifying the carbon nanostructure/substrate portion of the binary image.

4. The method of claim 3, wherein converting the image of the plurality of carbon nanostructures into a binary image further comprises pixelating the carbon nanostructure/substrate portion of the binary image into a plurality of pixels.

5. The method of claim 4, further comprising:
determining a number of pixels in the carbon nanostructure/substrate portion.

6. The method of claim 5, wherein correlating the carbon nanostructure/substrate portion of the binary image with an amount of carbon nanostructures infused to the substrate comprises inputting the number of pixels into a calibration function that relates the number of pixels to an amount of carbon nanostructures infused to the substrate.

7. The method of claim 1, wherein the substrate comprises a fiber.

8. The method of claim 7, wherein the fiber is moving while acquiring the image of the plurality of carbon nanostructures.

9. The method of claim 8, further comprising:
acquiring a plurality of images of the carbon nanostructures at spaced apart locations along the fiber;
converting each image into a binary image, each binary image comprising a carbon nanostructure/fiber portion and an extraneous portion; and
correlating the carbon nanostructure/fiber portion of each binary image with an amount of carbon nanostructures infused to the fiber at each spaced apart location along the fiber.

10. The method of claim 9, further comprising:
infusing a plurality of carbon nanostructures onto the fiber while it is moving, the carbon nanostructures being infused to the fiber under carbon nanostructure growth conditions.

11. The method of claim 10, further comprising:
determining if the amount of carbon nanostructures infused to the fiber is within a desired range; and
altering a parameter of the carbon nanostructure growth conditions in response to an out-of-range amount of carbon nanostructures.

12. The method of claim 11, wherein altering a parameter of the carbon nanostructure growth conditions comprises changing a linespeed of the fiber.

13. The method of claim 11, wherein altering a parameter of the carbon nanostructure growth conditions takes place in real-time or near real-time.

14. A method comprising:
infusing a plurality of carbon nanostructures onto a moving fiber under carbon nanostructure growth conditions;
acquiring a visible light image of the plurality of carbon nanostructures while they are infused to the moving fiber;
converting the visible light image of the plurality of carbon nanostructures into a binary image, the binary image comprising a carbon nanostructure/fiber portion and an extraneous portion;
identifying the carbon nanostructure/fiber portion of the binary image; and
correlating the carbon nanostructure/fiber portion of binary image with an amount of carbon nanostructures infused to the moving fiber.

15. The method of claim 14, wherein converting the visible light image of the plurality of carbon nanostructures into a binary image further comprises pixelating the carbon nanostructure/fiber portion of the binary image into a plurality of pixels.

16. The method of claim 15, further comprising:
determining a number of pixels in the carbon nanostructure/fiber portion.

17. The method of claim 16, wherein correlating the carbon nanostructure/fiber portion of binary image with an amount of carbon nanostructures infused to the moving fiber comprises inputting the number of pixels into a calibration function that relates the number of pixels to an amount of carbon nanostructures infused to the moving fiber.

18. The method of claim 14, further comprising:
acquiring a plurality of visible light images of the carbon nanostructures at spaced apart locations along the moving fiber;
converting each visible light image into a binary image, each binary image comprising a carbon nanostructure/fiber portion and an extraneous portion; and
correlating the carbon nanostructure/fiber portion of each binary image with an amount of carbon nanostructures infused to the moving fiber at each spaced apart location along the fiber.

19. The method of claim 18, further comprising:
determining if the amount of carbon nanostructures infused to the moving fiber is within a desired range; and
altering a parameter of the carbon nanostructure growth conditions in response to an out-of-range amount.

20. The method of claim 19, wherein altering a parameter of the carbon nanostructure growth conditions comprises changing a linespeed of the moving fiber.

21. The method of claim 19, wherein altering a parameter of the carbon nanostructure growth conditions takes place in real-time or near real-time.

22. The method of claim 14, wherein acquiring a visible light image of the plurality of carbon nanostructures while they are infused to the moving fiber comprises obtaining a first visible light image of the plurality of carbon nanostructures with a first image acquisition mechanism and a second visible light image of the plurality of carbon nanostructures with a second image acquisition mechanism, each image acquisition mechanism comprising a visible light camera and being configured to image the same location within the moving fiber but being differentially positioned relative to the moving fiber.

23. The method of claim 22, further comprising:
converting the first and second visible light images into first and second binary images, each binary image comprising a carbon nanostructure/fiber portion and an extraneous portion;
correlating the carbon nanostructure/fiber portion of each binary image with an amount of carbon nanostructures present therein; and
determining an amount of carbon nanostructures infused to the moving fiber based upon the amount of carbon nanostructures present in each binary image.

24. An imaging system comprising:
a carbon nanostructure growth chamber configured to infuse carbon nanostructures to one or more moving fibers under carbon nanostructure growth conditions;
a first image acquisition mechanism configured to obtain a first image of the one or more moving fibers after they have exited the carbon nanostructure growth chamber and had carbon nanostructures infused thereto; and
a processing mechanism configured to convert the first image into a first binary image having a carbon nanostructure/fiber portion and an extraneous portion, the processing mechanism also being configured to correlate the carbon nanostructure/fiber portion of the first binary image with an amount of carbon nanostructures infused to each moving fiber.

25. The imaging system of claim 24, wherein the processing mechanism is further configured to pixelate the carbon nanostructure/fiber portion of the first binary image into a first pixelated image comprising a plurality of pixels and to determine the number of pixels in the carbon nanostructure/fiber portion of the first pixelated image.

26. The imaging system of claim 24, wherein the first image acquisition mechanism comprises a visible light camera.

27. The imaging system of claim 24, further comprising:
a backlight disposed such that the one or more moving fibers are positioned between the first image acquisition mechanism and the backlight.

28. The imaging system of claim 24, further comprising:
a second image acquisition mechanism configured to image the same location within the one or more moving fibers as the first image acquisition mechanism and to obtain a second image thereof;
wherein the second image acquisition mechanism is differentially positioned with respect to the one or more moving fibers relative to the first image acquisition mechanism.

29. The imaging system of claim 28, wherein the first and second image acquisition mechanisms comprise visible light cameras.

30. The imaging system of claim 28, wherein the processing mechanism is further configured to convert the second image into a second binary image, the second binary image having a carbon nanostructure/fiber portion and an extraneous portion.

31. The imaging system of claim 30, wherein the processing mechanism is further configured to determine an amount of carbon nanostructures infused to each moving fiber based upon an amount of carbon nanostructures present in each binary image.

32. The imaging system of claim 24, further comprising:
a reel-to-reel processing system configured to convey the one or more fibers through the carbon nanostructure growth chamber, the reel-to-reel processing system comprising one or more tensioning rollers disposed before and after the carbon nanostructure growth chamber.

33. The imaging system of claim 32, wherein the first image acquisition mechanism is configured to obtain the first image of the one or more fibers between an exit of the carbon nanostructure growth chamber and before the one or more tensioning rollers disposed after the carbon nanostructure growth chamber.

34. The imaging system of claim 24, wherein the processing mechanism is further configured to change one or more parameters of the carbon nanostructure growth conditions in response to an out-of-range amount of carbon nanostructures infused to the one or more moving fibers.

35. The imaging system of claim 34, wherein the processing mechanism is configured to change a linespeed of the one or more moving fibers passing through the carbon nanostructure growth chamber in response to an out-of-range amount of carbon nanostructures infused to the one or more moving fibers.
